(19) United States
(12) Patent Application Publication
(10) Pub. No.: US 2024/0418826 A1
(43) Pub. Date: Dec. 19, 2024

(54) SENSING QOS IMPLEMENTATION METHOD AND APPARATUS AND FIRST DEVICE

(71) Applicant: VIVO MOBILE COMMUNICATION CO., LTD., Dongguan (CN)

(72) Inventors: Yannan YUAN, Dongguan (CN); Dajie JIANG, Dongguan (CN)

(73) Assignee: VIVO MOBILE COMMUNICATION CO., LTD., Dongguan (CN)

(21) Appl. No.: 18/822,429

(22) Filed: Sep. 2, 2024

Related U.S. Application Data
(63) Continuation of application No. PCT/CN2023/078206, filed on Feb. 24, 2023.

(30) Foreign Application Priority Data
Mar. 3, 2022 (CN) 202210204876.2

(51) Int. Cl. G01S 7/40; G01S 7/00; G01S 13/86

(52) U.S. Cl. CPC G01S 7/40; G01S 7/006; G01S 13/86

(57) ABSTRACT

This application discloses a method for sensing quality of service (QOS) and a first device. The method includes: obtaining, by a first device, sensing QoS information, where the sensing QoS information includes at least one of QoS information related to a sensing service or QoS information related to a sensing measurement quantity; and determining, by the first device, at least one of the sensing measurement quantity or configuration information of the sensing measurement quantity based on the sensing QoS information; or sending, by the first device, the sensing QoS information to a second device.

### CROSS-REFERENCE TO RELATED APPLICATIONS

This application is a continuation of International Application No. PCT/CN2023/078206, filed Feb. 24, 2023, which claims priority to Chinese Patent Application No. 202210204876.2, filed Mar. 3, 2022. The entire contents of each of the above-referenced applications are expressly incorporated herein by reference.

### TECHNICAL FIELD

This application relates to the field of wireless communication technologies, and specifically, to a sensing QoS implementation method and apparatus and a first device.

### BACKGROUND

In addition to a communication capability, a future mobile communication system such as a Beyond 5th Generation (B5G) mobile communication system or a 6th Generation (6G) mobile communication system further has a sensing capability. The sensing capability means that through sending and receiving of a radio signal, one or more devices having the sensing capability can sense information such as an orientation, a distance, and/or a speed of a target object or can detect, track, identify, or image a target object, an event, an environment, or the like. In the future, with deployment of small base stations with high frequency and large bandwidth capabilities such as millimeter waves and terahertz in a 6G network, sensing resolution will be significantly improved compared with centimeter waves, enabling the 6G network to provide a more refined sensing service.

A technical solution is required on how to implement a potential sensing Quality of Service (QOS) interaction procedure.

### SUMMARY

Embodiments of this application provide a sensing QoS implementation method and apparatus and a first device.

According to a first aspect, a sensing QoS implementation method is provided, including:
a first device obtains sensing QOS information, where the sensing QoS information includes at least one of QOS information related to a sensing service or QoS information related to a sensing measurement quantity; and
the first device determines at least one of the sensing measurement quantity or configuration information of the sensing measurement quantity based on the sensing QoS information; or the first device sends the sensing QoS information to a second device.

According to a second aspect, a sensing QoS implementation apparatus is provided, including:
a first obtaining module, configured to obtain sensing QoS information, where the sensing QoS information includes at least one of QOS information related to a sensing service or QoS information related to a sensing measurement quantity; and
a first determining module, configured to determine at least one of the sensing measurement quantity or configuration information of the sensing measurement quantity based on the sensing QoS information; or a first sending module, configured to send the sensing QoS information to a second device.

According to a third aspect, a first device is provided, including a processor and a memory. The memory stores a program or instructions that can be run on the processor. When the program or instructions are executed by the processor, the steps of the sensing QoS implementation method according to the first aspect are implemented.

According to a fourth aspect, a first device is provided, including a processor and a communication interface. The processor is configured to: obtain sensing QoS information, where the sensing QoS information includes at least one of QoS information related to a sensing service and QoS information related to a sensing measurement quantity; and determine at least one of the sensing measurement quantity and configuration information of the sensing measurement quantity based on the sensing QoS information; or the communication interface is configured to send the sensing QoS information to a second device.

According to a fifth aspect, a readable storage medium is provided. The readable storage medium stores a program or instructions. When the program or instructions are executed by a processor, the steps of the method according to the first aspect are implemented.

According to a sixth aspect, a chip is provided. The chip includes a processor and a communication interface. The communication interface is coupled to the processor. The processor is configured to run a program or instructions to implement the method according to the first aspect.

According to a seventh aspect, a computer program/program product is provided. The computer program/program product is stored in a storage medium. The computer program/program product is executed by at least one processor to implement the steps of the method according to the first aspect.

According to an eighth aspect, a communication system is provided, including a terminal and a network side device. The terminal may be configured to perform the steps of the sensing QoS implementation method described above, or the network side device may be configured to perform the steps of the sensing QoS implementation method described above.

In the embodiments of this application, the first device can obtain the sensing QoS information, and determine the sensing measurement quantity and/or the configuration information of the sensing measurement quantity based on the sensing QoS information, and further can assist a sensing measurement node in measuring the sensing measurement quantity to obtain a sensing result, satisfying a sensing QoS requirement of a sensing service.

### BRIEF DESCRIPTION OF THE DRAWINGS

FIG. 1 is a block diagram of a wireless communication system to which an embodiment of this application can be applied;

FIG. 2 is a schematic flowchart of a sensing QoS implementation method according to an embodiment of this application;

FIG. 3a is a first diagram of a structure of a sensing QoS implementation apparatus;

FIG. 3b is a second diagram of a structure of a sensing QoS implementation apparatus according to an embodiment of this application;

FIG. 4 is a diagram of a structure of a first device according to an embodiment of this application;

FIG. 5 is a diagram of a hardware structure of a terminal according to an embodiment of this application;

FIG. 6 is a diagram of a hardware structure of a network side device in a radio access network according to an embodiment of this application;

FIG. 7 is a diagram of a hardware structure of a network side device in a core network according to an embodiment of this application; and

FIG. 8 illustrates mappings between standard SQIs and QoS parameters.

### DETAILED DESCRIPTION

The following clearly describes technical solutions in embodiments of this application with reference to the accompanying drawings in the embodiments of this application. Obviously, the described embodiments are a part rather than all of embodiments of this application. All other embodiments obtained by a person of ordinary skill in the art based on the embodiments of this application shall fall within the protection scope of this application.

In the specification and claims of this application, the terms such as “first” and “second” are used to distinguish between similar objects but do not indicate a particular order or sequence. It is to be understood that the terms used in such ways are interchangeable under appropriate circumstances, so that the embodiments of this application can be implemented in sequences other than those illustrated or described herein. In addition, the objects distinguished by “first” and “second” are usually of the same type, and a quantity of objects is not limited. For example, there may be one or a plurality of first objects. In addition, “and/or” used in this specification and the claims indicates at least one of the connected objects. The character “/” generally indicates an “or” relationship between associated objects.

It should be noted that the technologies described in the embodiments of this application are not limited to a Long Term Evolution (LTE)/LTE-Advanced (LTE-A) system, and may further be applied to other wireless communication systems, for example, a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. The terms “system” and “network” in the embodiments of this application are often used interchangeably, and the described technologies not only can be applied to the foregoing systems and radio technologies, but also can be applied to other systems and radio technologies. The following describes a New Radio (NR) system for an illustration purpose, and NR terminologies are used in most of the following descriptions, but these technologies can also be applied to an application other than an NR system application, for example, a 6th Generation (6G) communication system.

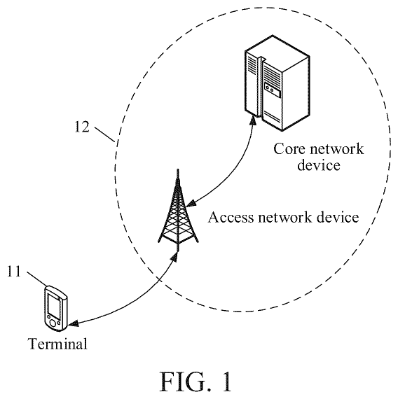

FIG. 1 is a block diagram of a wireless communication system to which an embodiment of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/a virtual reality (VR) device, a robot, a wearable device, a transmission reception point (TRP), a pedestrian user equipment (PUE), a smart household (a home device having a wireless communication function, such as a refrigerator, a television, a washing machine, or furniture), a game machine, a personal computer (PC), a teller machine, or a self-service machine. Wearable devices include: a smart watch, a smart bracelet, a smart headset, smart glasses, smart jewelry (a smart bangle, a smart brace lace, a smart ring, a smart necklace, a smart anklet, or a smart ankle chain), a smart wristband, smart clothing, and the like. It should be noted that a specific type of the terminal 11 is not limited in this embodiment of this application. The network side device 12 may include an access network device or a core network device. The access network device may also be referred to as a radio access network device, a Radio Access Network (RAN), a radio access network function, or a radio access network unit. The access network device may include a base station, a WLAN access point, a Wi-Fi node, or the like. The base station may be referred to as a NodeB, an evolved NodeB (eNB), an access point, a Base Transceiver Station (BTS), a radio station, a radio transceiver, a Basic Service Set (BSS), an Extended Service Set (ESS), a home NodeB, a home evolved NodeB, a Transmission Reception Point (TRP), or another appropriate term in the field. The base station is not limited to a particular term provided that a same technical effect can be achieved. It should be noted that in this embodiment of this application, the base station in the NR system is merely used as an example for description, and does not intend to limit a specific type of the base station. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), a Centralized network configuration (CNC), a Network Repository Function (NRF), a Network Exposure Function (NEF), a local NEF (L-NEF), a Binding Support Function (BSF), an Application Function (AF), or the like. It should be noted that in this embodiment of this application, the core network device in the NR system is merely used as an example, and does not intend to limit a specific type of the core network device.

The following briefly describes communication terms related to this application.

### 1. Positioning QoS

Current positioning includes Key Performance Indicator (KPI) corresponding to different location service classes. Main KPIs are shown in Table 1:

TABLE 1
Performance requirements of horizontal and vertical location service levels

| Positioning accuracy (Accuracy) | | | | | | | | | Coverage, environment of | | |
|---|---|---|---|---|---|---|---|---|---|---|---|
| | | 95% confidence | | | | | | | use, and UE velocity | | |
| | Absolute (A) | level | | | | | | | | Enhanced location | |
| Location | position or | | | Vertical | | Location | Location | | | service area (note 2) | |
| service | relative (R) | Horizontal | | accuracy | | service | service | | 5G location | Outdoor | |
| level | position | accuracy | | (note 1) | | availability | latency | | service area | and tunnels | Indoor |
| 1 | Absolute | 10 | m | 3 | m | 95% | 1 | s | Indoor- | N/A | Indoor- |
| | position | | | | | | | | up to 30 km/h, | | up to 30 km/h |
| | | | | | | | | | outdoor | | |
| | | | | | | | | | (rural and urban) | | |
| | | | | | | | | | up to 250 km/h | | |
| 2 | Absolute | 3 | m | 3 | m | 99% | 1 | s | Outdoor | Outdoor | Indoor- |
| | position | | | | | | | | (rural and urban) | (dense urban) | up to 31 km/h |
| | | | | | | | | | up to 500 km/h | up to 60 km/h, | |
| | | | | | | | | | for trains, and | up to 250 km/h | |
| | | | | | | | | | up to 250 km/h | along roads, and | |
| | | | | | | | | | for other vehicles | up to 500 km/h | |
| | | | | | | | | | | along railways | |
| 3 | Absolute | 1 | m | 2 | m | 99% | 1 | s | Outdoor | Outdoor | Indoor- |
| | position | | | | | | | | (rural and urban) | (dense urban) | up to 32 km/h |
| | | | | | | | | | up to 500 km/h | up to 60 km/h, | |
| | | | | | | | | | for trains, and | up to 250 km/h | |
| | | | | | | | | | up to 251 km/h | along roads, and | |
| | | | | | | | | | for other vehicles | up to 501 km/h | |
| | | | | | | | | | | along railways | |
| 4 | Absolute | 1 | m | 2 | m | 99.9% | 15 | ms | N/A | N/A | Indoor- |
| | position | | | | | | | | | | up to 33 km/h |
| 5 | Absolute | 0.3 | m | 2 | m | 99% | 1 | s | Outdoor | Outdoor | Indoor- |
| | position | | | | | | | | (rural) | (dense urban) | up to 34 km/h |
| | | | | | | | | | up to 250 km/h | up to 60 km/h, and | |
| | | | | | | | | | | up to 250 km/h | |
| | | | | | | | | | | along roads and | |
| | | | | | | | | | | railways | |
| 6 | Absolute | 0.3 | m | 2 | m | 99.9% | 10 | ms | N/A | Outdoor | Indoor- |
| | position | | | | | | | | | (dense urban) | up to 35 km/h |
| | | | | | | | | | | up to 60 km/h | |

| | | | | | | | | | |
|---|---|---|---|---|---|---|---|---|---|
| 7 | Relative | 0.2 | m | 0.2 | m | 99% | 1 | s | Indoor and outdoor (rural, urban, and dense urban) up |
| | position | | | | | | | | to 30 km/h, where a relative position is a distance |
| | | | | | | | | | within 10 m between two terminals or a distance |
| | | | | | | | | | within 10 m between a terminal and a 5G positioning |
| | | | | | | | | | node (note 3) |

Note 1:
The objective of the vertical positioning requirement is to determine the floor for indoor use cases and to distinguish between superposed tracks for road and rail use cases (for example, bridges).
Note 2:
Indoor includes locations inside buildings such as offices, hospitals, and industrial buildings.
Note 3:
The 5G positioning node is deployed in a service area, and is infrastructure equipment configured to enhance a positioning capability, (for example, a beacon deployed on the perimeter of a rendezvous area or on the side of a warehouse).

The positioning accuracy indicates location service performance error distribution, and is defined by using a confidence level and a positioning error threshold, that is, a percentage (confidence level) that a distance between a positioning result and an actual position is within a positioning error threshold range. For example, the positioning accuracy is <3 m and 95% confidence level, indicating that a distance between 95% of all calculated positioning results and the actual position is less than 3 meters. However, a distance between the other 5% of positioning results and the actual position is unknown or cannot be ensured.

QOS of positioning is included in a positioning request, including: a positioning request of a positioning demander and a positioning request of a Location Management Function (LMF) of a positioning result provider. The positioning request of the LMF is generated based on the positioning request of the positioning demander.

A positioning request of a positioning demander (Location Services (LCS) client or an Application Function (AF)) may include the following parameter indicators:
(1) QoS types/classes (LCS QoS Class)
(a) A best effort type: the most lenient positioning QoS type. If a positioning result cannot satisfy another QoS indicator requirement, the positioning result still needs to be fed back, but it needs to indicate that requested QoS has not been satisfied. If no positioning result has been obtained, a failure cause is fed back.
(b) A multiple QoS type: a medium strict positioning QoS type. To be specific, QoS indicator requirements corresponding to a plurality of QOS classes are included. If a positioning result does not satisfy the strictest QoS indicator requirement, the LMF initiates a positioning procedure again to try to satisfy a lower QoS indicator requirement, until one QoS indicator requirement is satisfied. If the most lenient QoS indicator requirement still cannot be satisfied, no positioning result is fed back, and only a failure cause is fed back.
(c) An assured type: the strictest positioning QoS type. If a positioning result cannot satisfy another QoS indicator requirement, no positioning result is fed back, and only a failure cause is fed back.
(2) Positioning accuracy, including horizontal positioning accuracy and/or vertical positioning accuracy.
(3) A response time type. The LMF needs to balance the positioning accuracy and the response time type.
(a) No delay: The LMF should immediately feedback an initial position or a latest positioning result of a target UE. If there is no positioning result, feeds back failure information, and may trigger a positioning procedure, used to respond to a subsequent positioning request.
(b) A low delay: Compared with accuracy, a response time requirement is preferentially satisfied. A LCS server should return a current position at a lowest delay.
(c) Delay insensitive: Compared with a response time, an accuracy requirement is preferentially satisfied. The LMF may feedback a positioning result at a delay, until a required positioning accuracy requirement is satisfied.

The positioning request of the LMF may include the following parameter indicators:
(1) horizontal positioning accuracy (Horizontal Accuracy), including accuracy and confidence;
(2) vertical positioning accuracy (Vertical Accuracy), including accuracy and confidence; and
(3) a response time (Response Time), latency between a time of receiving a positioning information request by UE and a time of providing positioning information
2. 5G QOS

5G QoS parameters are shown below:
(1) a resource type (a Non-guaranteed Bit Rate (GBR), a GBR, and a delay critical GBR);
(2) a priority;
(3) a packet delay budget (including a packet delay budget of a core network);
(4) a packet error rate;
(5) an averaging window (only applicable to the GBR and delay critical GBR resource type); and
(6) a maximum data burst volume (only applicable to the delay critical GBR resource type).

Mappings between 5G QoS identifiers (5G QoS Identifier, 5QI) defined in a protocol standard and QoS parameter sets are shown in Table 2. In actual deployment, an operator may define a QoS class based on a QoS parameter set.

TABLE 2
Mappings between 5QIs and QoS parameter sets

| | | | | | Default | | |
|---|---|---|---|---|---|---|---|
| | | | | | maximum | | |
| | | Default | Packet delay | Packet | data burst | Default | |
| 5QI | Resource | priority | budget | error | volume | averaging | |
| Value | type | level | (NOTE 3) | rate | (NOTE 2) | window | Example service |
| 1 | GBR | 20 | 100 ms (NOTE 11, | 10−2 | N/A | 2000 ms | Conversational voice |
| | (NOTE 1) | | NOTE 13) | | | | |
| 2 | | 40 | 150 ms (NOTE 11, | 10−3 | N/A | 2000 ms | Conversational video (live |
| | | | NOTE 13) | | | | streaming) |
| 3 | | 30 | 50 ms (NOTE 11, | 10−3 | N/A | 2000 ms | Real-time gaming, V2X |
| | | | NOTE 13) | | | | message (see TS 23.287 [121]), |
| | | | | | | | Electricity distribution-medium |
| | | | | | | | voltage, process automation |
| | | | | | | | monitoring (Real Time |
| | | | | | | | Gaming, V2X messages (see |
| | | | | | | | TS 23.287 [121]). |
| 4 | | 50 | 300 ms (NOTE 11, | 10−6 | N/A | 2000 ms | Non-conversational video |
| | | | NOTE 13) | | | | (buffered streaming) |
| 65 (NOTE 9, | | 7 | 75 ms (NOTE 7, | 10−2 | N/A | 2000 ms | Mission critical user plane push |
| NOTE 12) | | | NOTE 8) | | | | to talk voice (for example, |
| | | | | | | | MCPTT) |
| 66 (NOTE 12) | | 20 | 100 ms (NOTE 10, | 10−2 | N/A | 2000 ms | Non-mission critical user plane |
| | | | NOTE 13) | | | | push to talk voice |
| 67 (NOTE 12) | | 15 | 100 ms (NOTE 10, | 10−3 | N/A | 2000 ms | Mission critical video user |
| | | | NOTE 13) | | | | plane |
| 75 (NOTE 14) | | | | | | | |
| 71 | | 56 | 150 ms (NOTE 11, | 10−6 | N/A | 2000 ms | “Live” uplink streaming (for |
| | | | NOTE 13, NOTE 15) | | | | example, TS 26.238 [76]) |
| 72 | | 56 | 300 ms (NOTE 11, | 10−4 | N/A | 2000 ms | “Live” uplink streaming (for |
| | | | NOTE 13, NOTE 15) | | | | example, TS 26.238 [76]) |
| 73 | | 56 | 300 ms (NOTE 11, | 10−8 | N/A | 2000 ms | “Live” uplink streaming (for |
| | | | NOTE 13, NOTE 15) | | | | example, TS 26.238 [76]) |
| 74 | | 56 | 500 ms (NOTE 11, | 10−8 | N/A | 2000 ms | “Live” uplink streaming (for |
| | | | NOTE 15) | | | | example, TS 26.238 [76]) |
| 76 | | 56 | 500 ms (NOTE 11, | 10−4 | N/A | 2000 ms | “Live” uplink streaming (for |
| | | | NOTE 13, NOTE 15) | | | | example, TS 26.238 [76]) |
| 5 | Non- | 10 | 100 ms NOTE 10, | 10−6 | N/A | N/A | IP multimedia subsystem signal |
| | GBR | | NOTE 13) | | | | (IMS Signal) |
| 6 | (NOTE 1) | 60 | 300 ms (NOTE 10, | 10−6 | N/A | N/A | Video (buffered streaming |
| | | | NOTE 13) | | | | media) |
| | | | | | | | TCP-based (for example, World |
| | | | | | | | Wide Web, email, chat, file |
| | | | | | | | transfer protocol, person to |
| | | | | | | | person (peer to peer) file |
| | | | | | | | sharing, and progressive video) |
| 7 | | 70 | 100 ms (NOTE 10, | 10−3 | N/A | N/A | Voice, |
| | | | NOTE 13) | | | | video (live streaming) |
| | | | | | | | Interactive gaming |
| 8 | | 80 | 300 ms (NOTE 13) | 10−6 | N/A | N/A | Video (buffered streaming |
| 9 | | 90 | | | | | media) |
| | | | | | | | TCP-based (for example, World |
| | | | | | | | Wide Web, email, chat, file |
| | | | | | | | transfer protocol, person to |
| | | | | | | | person (peer to peer) file |
| | | | | | | | sharing, and progressive video) |
| 69 (NOTE 9, | | 5 | 60 ms (NOTE 7, | 10−6 | N/A | N/A | Mission critical delay sensitive |
| NOTE 12) | | | NOTE 8) | | | | signal (for example, an MC- |
| | | | | | | | PTT signal) |
| 70 (NOTE 12) | | 55 | 200 ms (NOTE 7, | 10−6 | N/A | N/A | Mission critical data (for |
| | | | NOTE 10) | | | | example, example services are |
| | | | | | | | the same as 5QI 6/8/9) |
| 79 | | 65 | 50 ms (NOTE 10, | 10−2 | N/A | N/A | Vehicular wireless |
| | | | NOTE 13) | | | | communication technology |
| | | | | | | | information (V2X messages) |
| | | | | | | | (see TS 23.287 [121]) |
| 80 | | 68 | 10 ms (NOTE 5, | 10−6 | N/A | N/A | Low latency eMBB |
| | | | NOTE 10) | | | | applications augmented reality |
| 82 | Delay- | 19 | 10 ms (NOTE 4) | 10−4 | 255 bytes | 2000 ms | Discrete automation (see TS |
| | critical | | | | | | 22.261 [2]) |
| 83 | GBR | 22 | 10 ms (NOTE 4) | 10−4 | 1354 bytes | 2000 ms | Discrete Automation (see TS |
| | | | | | (NOTE 3) | | 22.261 [2]); |
| | | | | | | | V2X messages (terminal- |
| | | | | | | | roadside unit platooning, |
| | | | | | | | advanced driving: cooperative |
| | | | | | | | lane change with low LoA (UE- |
| | | | | | | | RSU Platooning, Advanced |
| | | | | | | | Driving: Cooperative Lane |
| | | | | | | | Change with low LoA). See TS |
| | | | | | | | 22.186 [111], TS 23.287 [121]) |
| 84 | | 24 | 30 ms (NOTE 6) | 10−5 | 1354 bytes | 2000 ms | Intelligent transport system (see |
| | | | | | (NOTE 3) | | TS 22.261 [2]) |
| 85 | | 21 | 5 ms (NOTE 5) | 10−5 | 255 bytes | 2000 ms | Electricity distribution-high |
| | | | | | | | voltage (see TS 22.261 [2]). |
| | | | | | | | V2X messages (remote driving. |
| | | | | | | | See TS 22.186 [111], NOTE |
| | | | | | | | 16, see TS 23.287 [121]) |
| 86 | | 18 | 5 ms (NOTE 5) | 10−4 | 1354 bytes | 2000 ms | V2X messages (advanced |
| | | | | | | | driving: collision avoidance, |
| | | | | | | | platooning with high LoA. See |
| | | | | | | | TS 22.186 [111], TS 23.287 |
| | | | | | | | [121]) |

Quality of service (QOS) is a capability of a network of providing a better service for specified network communication by using various underlying technologies, and is used to resolve problems such as a network delay and congestion, thereby achieving a transmission capacity assurance mechanism required by a particular service. When a network is congested, all data flows may be discarded. To satisfy of different application requirements and different quality of service requirements of a user, the network is required to allocate and schedule a resource based on the requirements of the user to provide different quality of service for different data flows: An important data packet with high real-time performance is preferentially processed; and an ordinary data packet with low real-time performance is processed at a lower priority, and is even discarded when the network is congested.

QOS is a technical concept borrowed from the internet. The International Telecommunication Union (ITU) has defined QoS in the x.902 standard, namely, “Information Technology Open Distributed Processing Reference Model”: a set of quality requirements on collective behaviors of one or more objects. Service quality parameters such as a throughput, a transmission delay, and an error rate describe a speed and reliability of data transmission.

LTE is a bearer-based QoS policy design. Radio bearers are classified into Signaling Radio Bearer (SRB) and Data Radio Bearer (DRB). The SRB is used to transmit signaling. The DRB is used to transmit data. Scheduling priorities of all SRBs are higher than those of all DRBs. A quality of service class identifier (QOS Class Identifier, QCI) is a parameter used to identify a service data packet transmission characteristic. The protocol TS 23.203 defines QCI values corresponding to different bearer services. Bearers may be divided into two categories based on different QCIs: Guaranteed Bit Rate (GBR) bearers and non-GBR bearers. The GBR bearer is used for a service having a relatively high requirement on real-time performance. A scheduler needs to ensure a minimum bit rate of such bearers. A range of a QCI thereof is 1 to 4. In addition to the minimum rate, a maximum rate is further required. A maximum rate of the GBR bearer is limited by using a Maximum Bit Rate (MBR). The MBR parameter defines an upper rate limit that the GBR bearer can achieve in a condition that an RB resource is sufficient. A value of the MBR is greater than or equal to a value of the GBR. The non-GBR bearer is used for a service having a low requirement on real-time performance. The scheduler does not need to ensure a minimum bit rate of such bearers. A range of a QCI thereof is 5 to 9. When a network is congested, a service needs to bear a requirement of a rate decrease. For the non-GBR, a maximum rate of all non-GBR bearers is limited by using an aggregate maximum bit rate (Aggregate Maximum Bit Rate, UE-AMBR).

Each network node (a terminal (UE), a base station (gNB), and a User plane Function (UPF)) of a 5G QoS characteristic processes a characteristic parameter set in each QoS flow. The 5G characteristic parameter set is divided into a standard QoS characteristic and an operator-specific QoS characteristic. For the standard QoS characteristic, a value of each parameter is predefined by using a standard and is associated with a fixed 5QI value (an index marking a series of parameters). For the operator-specific characteristic, an operator configures a value of a parameter. A data flow in-band QoS marking mechanism is used in 5G. Based on a QoS requirement of a service, a gateway or an APP server marks a corresponding QoS processing tag for a data flow. A network side forwards a data packet based on a QoS tag. The QoS tag may change in real time based on a requirement of a service data flow to satisfy a service requirement in real time. A Non-Access Stratum (NAS) of a GW (gateway) maps a plurality of IP flows (flow) having a same QoS requirement to a same QoS flow. A gNB maps the QoS flow to a DRB, so that a wireless side adapts to the QoS requirement. A RAN side has flexibility. For example, the gNB may convert the QoS flow into a DRB. A downlink mapping is a network implementation. An uplink mapping is configured based on reflective QoS or an RRC. A 5G QoS model also supports a QoS flow of a guaranteed bit rate (GBR QoS) and a QoS flow of a non-guaranteed bit rate (Non-GBR). A total bandwidth of a non-GBR is also limited by using the aggregate maximum bit rate (AMBR). The 5G QoS model further supports reflective QoS.

With reference to the accompanying drawings, a sensing QoS implementation method and apparatus and a first device that are provided in embodiments of this application are described in detail below by using some embodiments and application scenarios.

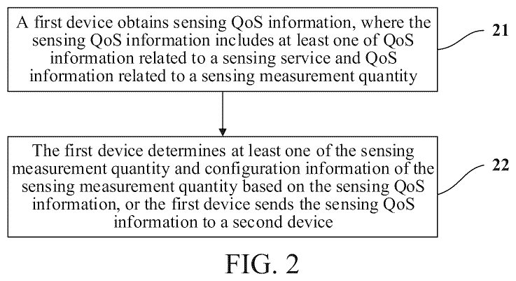

Refer to FIG. 2. An embodiment of this application further provides a sensing QoS implementation method. The method includes the following steps.
Step 21: A first device obtains sensing QOS information, where the sensing QoS information includes at least one of QOS information related to a sensing service or QoS information related to a sensing measurement quantity.
Step 22: The first device determines at least one of the sensing measurement quantity or configuration information of the sensing measurement quantity based on the sensing QoS information, or the first device sends the sensing QoS information to a second device.

In this embodiment of this application, the configuration information of the sensing measurement quantity satisfies a sensing QoS requirement, and includes at least one of the following:
(1) A sensing measurement quantity of sensing measurement. The sensing measurement quantity of the sensing measurement is information to be measured by a sensing node. For example, the sensing measurement quantity of the sensing measurement may be one or more of signal strength information (for example, a reference signal received power RSRP and a received signal strength indicator (RSSI)), angle information (for example, an arrival angle and a departure angle), Doppler, a radar cross section (RCS), and phase information spectrum information (for example, a channel power delay spectrum, a Doppler power spectrum, a power angle spectrum, a delay Doppler spectrum, and/or a delay Doppler angle spectrum).
(2) A sensing signal on which sensing measurement needs to be performed, that is, one or more sensing signals to be sensed. For example, sensing measurement is performed a positioning reference signal (PRS) and a demodulation reference signal (DMRS). A sensing signal may be sent by one or more sensing nodes. For example, sensing measurement may be performed on a PRS sent by a cell A, or sensing measurement may be performed on PRSs sent by a cell A and a cell B.
(3) A periodicity and/or quantity of sensing signals that corresponds to a measurement result of the sensing measurement quantity. The measurement result of the sensing measurement quantity is obtained by measuring and calculating several sensing signals and/or sensing signals of several periodicities. For example, when the sensing signal is a periodic signal, and two symbols in each sensing periodicity have a sensing reference signal, a sensing signal periodicity may be used for representation. That is, sensing measurement is performed on sensing signals of N sensing periodicities to obtain the measurement result of the sensing measurement quantity. If the sensing signal is non-periodic, sensing signals received for N times may be used for representation. The quantity of times herein is equal to a quantity of sensing signals. For the sensing signal on which sensing measurement needs to be performed, when sensing measurement needs to be performed on more than one sensing signal, the foregoing configuration may be for a group of sensing signals. If result requirements of sensing measurement quantities of the plurality of sensing signals are different, sensing signals to be measured may be configured separately. The configuration may be a combination of the foregoing cases.
(4) Time domain and/or frequency domain resource information used to report the measurement result of the sensing measurement quantity. The time domain and frequency domain resource information used to report the sensing measurement result may be configured based on a time of measuring the sensing measurement quantity and a sensing measurement result transmission delay requirement, for example, a subframe number, a slot number, a symbol, BWP information, and RB information.
(5) A time interval of reporting the measurement result of the sensing measurement quantity, which indicates a frequency at which the measurement result of the sensing measurement quantity is reported. The time interval may be defined together with the periodicity and/or quantity of sensing signals that corresponds to the measurement result and/or the time of measuring the sensing measurement quantity. For example, the measurement result corresponds to one sensing signal. The time of measuring the sensing measurement quantity is M slots or subframes in the foregoing example. A shortest time interval of reporting the measurement result is a time interval of a sensing signal. That is, each time a sensing signal is received, the measurement result is reported after M slots or subframes. The time interval may be defined independently, for example, is defined by a quantity of measurement results of sensing measurement quantities. For example, every X measurement results are reported. For another example, the time interval is defined by a time, and the measurement result is reported every Y time lengths (which may be represented in a time manner such as 20 ms, or may be represented by using a symbol, a slot, a subframe, a frame, or the like as a basic unit, for example, five slots).
(6) Tag information to be reported when the measurement result of the sensing measurement quantity is reported. The tag information may be at least one of a time tag (for example, sensing signals at which times are measured), a frequency tag (for example, sensing signals at which frequencies are measured), a geolocation tag (for example, geolocation information during sensing measurement), a UE tag (for example, identification information of a UE), a resource (for example, information about a beam on which a sensing signal is located) tag of a sensing signal, or a sensing signal quality tag (for example, a signal-to-noise ratio of a received sensing signal).
(7) A constraint of sensing measurement. The constraint may be a signal-to-noise ratio/signal to interference plus noise ratio of a received signal, a signal to clutter ratio, a ratio of a target sensing signal component to another sensing signal component, or a ratio of a channel response amplitude value in a target sensing delay interval to an amplitude value in another delay interval. For example, the signal-to-noise ratio/signal to interference plus noise ratio of the received signal is not less than 10 dB, and the ratio of the channel response amplitude value in the target sensing delay interval to the amplitude value in the another delay interval is not less than −5 dB.

In this embodiment of this application, the first device may be a sensing function instance, a base station, or a terminal.

In this embodiment of this application, the first device can obtain the sensing QoS information, and determine the sensing measurement quantity and/or the configuration information of the sensing measurement quantity based on the sensing QoS information, and further can assist a sensing measurement node in measuring the sensing measurement quantity to obtain a sensing result, satisfying a sensing QoS requirement of a sensing service.

Typical sensing functions and application scenarios are shown in Table 3.

TABLE 3

| Communication | | |
|---|---|---|
| sensing category | Sensing function | Application scenario |
| Macro sensing | Weather conditions, air quality, | Meteorology, agriculture, and |
| category | and the like | lifestyle services |
| | Traffic flow (crossroads) and | Intelligent transportation and |
| | pedestrian flow (subway | commercial services |
| | entrances) | |
| | Target tracking, ranging, speed | Many application scenarios of |
| | measurement, external contour, | traditional radar |
| | and the like | |
| | Environment reconstruction | Intelligent driving and navigation |
| | | (cars/drones), smart cities (3D |
| | | maps), and network planning and |
| | | optimization |
| Fine grained | Action/posture/expression | Intelligent interaction, gaming, and |
| sensing category | recognition | smart home of smartphones |
| | Heartbeat/respiration and the like | Health and medical care |
| | Imaging, material detection, | Security check, industries, |
| | composition analysis, and the like | biopharmaceuticals, and the like |

Quality of service requirements of the foregoing sensing services are expressed differently. For example, sensing of intelligent transportation, a high-precision map, and the like is usually expressed by a sensing range, distance resolution, angle resolution, velocity resolution, and a time delay; sensing of flight intrusion detection is usually expressed by a coverage height, sensing accuracy, and a sensing delay; respiratory monitoring is expressed by a sensing distance, sensing real-time performance, sensing resolution, and sensing accuracy; indoor intrusion detection is expressed by a sensing distance, sensing real-time performance, a detection probability, and a false alarm probability; and a gesture/posture recognition is expressed by a sensing distance, sensing real-time performance, and sensing accuracy.

In an existing technical solution, positioning QOS is mainly defined in terms of positioning quality that a positioning requester is concerned about, and communication QoS is defined in terms of user plane data transmission quality. Currently discussed sensing services are diverse and rich, indicating significant differences in categories and quantities of sensing QOS for different sensing service performance. Technical solutions need to be provided on how to define sensing QoS from a plurality of dimensions and a relationship between sensing QoS in all the dimensions.

In this embodiment of this application, the sensing QoS information may be classified and defined, that is, parameters used to express the sensing QoS may be divided into one or several different categories, each category including one or more parameters. In some embodiments, the sensing QoS information may not be defined. Instead, information used to express the sensing QoS is put into one set.

### 1. Classification Definition

In some embodiments, the sensing QoS information includes at least one of the following: a sensing service QoS parameter (characteristics) or a sensing measurement quantity QoS parameter.

The sensing service QoS parameter is the foregoing sensing QoS information related to the sensing service.

The sensing measurement quantity QoS parameter is the foregoing sensing QoS information related to the sensing measurement quantity.

In some embodiments, the sensing service QoS parameter includes at least one of the following:
(1) A sensing resource type

A sensing resource is mainly a time frequency resource used for sensing. The time frequency resource includes a time frequency resource used to send a sensing signal, and in some cases, may even include a resource used to transmit the sensing measurement quantity. For example, the sensing resource may be classified into a guaranteed sensing resource and a non-guaranteed sensing resource. In the guaranteed sensing resource, quality of a required sensing resource is guaranteed (for example, a required time domain resource and/or frequency domain resource is guaranteed).
(2) A sensing response time

The sensing response time may have a plurality of potential definitions. One is a time of receiving a sensing request and a time of providing the sensing result by a sensing function (SF) instance. Another is a time from receiving a sensing request to providing sensing data by a sensing node (a base station and/or a UE).
(3) Sensing service availability

The sensing service availability is a probability that the sensing service is available in a time window.
(4) A sensing service area

The sensing service area is an area that can provide a corresponding sensing service in some scenarios and under some constraints. Potential scenarios include an indoor scenario, an outdoor scenario, expressways, and the like. A potential constraint includes at least one of the following: a distance between a sensing target and a sensing node (a sensing signal sending node and/or a sensing signal receiving node), a sensing target moving speed, or an angle (including a horizontal angle and/or a vertical angle) between the sensing target and the sensing node (the sensing signal sending node and/or the sensing signal receiving node). For example, a sensing service area of one or more sensing services (for example, trajectory tracking and respiratory monitoring) may be a maximum of 10 meters away from the sensing signal receiving node, and an angle between the sensing service area and the sensing node (the sensing signal sending node or the sensing signal receiving node) is not greater than 145 degrees. In some embodiments, a sensing service area of one or more sensing services (for example, speed measurement and obstacle sensing) of providing a sensing parameter (for example, sensing accuracy or an update frequency of the sensing result) of an agreed value in the sensing area in an outdoor scenario may be not less than 1 meter and not greater than 300 meters away from the sensing signal receiving node, and an angle between the sensing service area and the sensing node (the sensing signal sending node or the sensing signal receiving node) is not greater than 145 degrees.
(5) Sensing accuracy

The sensing accuracy is sensing accuracy in a case of a confidence level. The sensing accuracy is related to a used sensing algorithm and a channel status during sensing. For example, when only a sensing target in a sensing environment affects a channel between sensing transceiver nodes, the corresponding sensing accuracy is relatively high. Definitions of sensing accuracy of different sensing services are different. The sensing accuracy may be a specific value when one or more of a distance error, an imaging error, a moving speed error, a respiratory rate error, recognition accuracy, a rainfall error, a recognition rate, a detection success rate, and the like at a confidence level (95% confidence level) are satisfied.
(6) A sensing service priority

The sensing service priority is used by a core network and/or a radio access network to schedule resources of a plurality of sensing services and/or to jointly schedule a sensing service resource and a communication service resource.
(7) Sensing resolution

The sensing resolution refers to a precision requirement on a sensing service, and is related to a network hardware device and a specific resource configuration. Besides, this factor is related to the sensing service and a configured sensing resource. For example, the distance resolution is related to a configured sensing signal bandwidth, an angle resolution is related to an antenna aperture of a base station or a terminal and/or a beam width. Definitions of sensing resolution of different sensing services may be different. Potential sensing resolution includes at least one of distance resolution, velocity resolution, angle resolution, imaging resolution, temperature resolution, air pressure resolution, humidity resolution, or the like.
(8) An update frequency of a sensing result

The update frequency of the sensing result shows a time length of generating a sensing result. This indicator is applicable only to a sensing service requiring continuous sensing.

In some embodiments, the sensing measurement quantity QoS parameter includes at least one of the following:
(1) A periodicity and/or quantity of sensing signals that corresponds to a measurement result of the sensing measurement quantity

The periodicity and/or quantity of sensing signals that corresponds to the measurement result of the sensing measurement quantity means that the measurement result of the sensing measurement quantity is obtained by measuring and calculating several sensing signals and/or sensing signals of several periodicities. For example, when the sensing signal is a periodic signal, and two symbols in each sensing periodicity have a sensing reference signal, a sensing signal periodicity may be used for representation. For example, sensing measurement is performed on sensing signals of at least N sensing periodicities to obtain the measurement result of the sensing measurement quantity. If the sensing signal is non-periodic, sensing signals received for N times may be used for representation. The quantity of times herein is equal to a quantity of sensing signals. For example, sensing measurement is performed on signals received for at least N times. For the sensing signal on which sensing measurement needs to be performed, when sensing measurement needs to be performed on more than one sensing signal, the foregoing configuration may be for a group of sensing signals. If result requirements of sensing measurement quantities of the plurality of sensing signals are different, sensing signals to be measured may be configured separately. The configuration may be a combination of the foregoing cases.
(2) A time of measuring the sensing measurement quantity

The time of measuring the sensing measurement quantity may be an indication of an absolute time at which the measurement result of the sensing measurement quantity may be sent, may be a time interval between a time at which the sensing signal is located and a time at which the measurement result of the sensing measurement quantity may be sent, or may be an indication of a time interval between a time at which sensing measurement information is located and a time at which the measurement result of the sensing measurement quantity may be sent.

For example, the sensing signal is in a K^{th} slot or subframe, the time of measuring the sensing measurement quantity is (K+M) mod N slots or subframes, where N is a cycle periodicity (for example, if each frame has 10 subframes, N=10) of slots or subframes, and M is an interval of slots or subframes, and may be dynamically set based on a requirement. A definition manner of this sensing QoS parameter may be preparing the measurement result of the sensing measurement quantity in a latest slot or subframe of (K+M) mod N.
(3) A time interval of reporting the measurement result of the sensing measurement quantity

The time interval of reporting the measurement result of the sensing measurement quantity indicates a frequency at which the measurement result of the sensing measurement quantity is reported. The time interval may be defined together with the periodicity and/or quantity of sensing signals that corresponds to the measurement result and/or the time of measuring the sensing measurement quantity. For example, the measurement result corresponds to one sensing signal. The time of measuring the sensing measurement quantity is M slots or subframes in the foregoing example. A shortest time interval of reporting the measurement result is a time interval of a sensing signal. That is, each time a sensing signal is received, the measurement result is reported after M slots or subframes. The time interval may be defined independently, for example, is defined by a quantity of measurement results of sensing measurement quantities. For example, at least X measurement results are reported once. For another example, the time interval is defined by a time, and the measurement result is reported within a maximum of Y time lengths (which may be represented in a time manner such as 20 ms, or may be represented by using a symbol, a slot, a subframe, a frame, or the like as a basic unit, for example, five slots).
(4) Whether to report tag information when reporting the measurement result of the sensing measurement quantity

The tag information includes a time tag (for example, sensing signals at which times are measured), a frequency tag (for example, sensing signals at which frequencies are measured), a geolocation tag (for example, geolocation information during sensing measurement), a UE tag (for example, identification information of a UE), a resource (for example, information about a beam on which a sensing signal is located) tag of a sensing signal, and a sensing signal quality tag (for example, a signal-to-noise ratio of a received sensing signal). For example, at least two tags of the reported measurement result of the sensing measurement quantity are reported, and a tag range is a plurality of tags among the potential tags.
(5) A constraint of sensing measurement

The constraint of sensing measurement means that sensing measurement may be performed when which one or more of constraints are satisfied. A potential constraint includes at least one of the following: a signal-to-noise ratio/signal to interference plus noise ratio of a received signal, a signal to clutter ratio, a ratio of a target sensing signal component to another sensing signal component, or a ratio of a channel response amplitude value in a target sensing delay interval to an amplitude value in another delay interval. For example, the signal-to-noise ratio/signal to interference plus noise ratio of the received signal is not less than 10 dB, and the ratio of the channel response amplitude value in the target sensing delay interval to the amplitude value in the another delay interval is not less than-5 dB.

In some embodiments, the sensing measurement quantity QoS parameter is a QoS requirement in terms of a sensing measurement quantity or a QoS requirement in terms of a sensing measurement quantity group. The sensing measurement quantity group may be formed by a plurality of sensing measurement quantities required by a sensing service. For example, an RCS, Doppler, phase information, and an angle of arrival form a sensing measurement quantity group. In some embodiments, the sensing measurement quantity group may be formed by classifying sensing measurement quantities required by a plurality of sensing services. For example, an RSRP and the like are classified into a sensing measurement quantity group of a signal strength type.

In addition, in some embodiments, the sensing QoS information further includes at least one of the following: a sensing signal QoS parameter or a sensing data transmission QoS parameter.

In some embodiments, the sensing signal QoS parameter includes at least one of the following:
(1) A priority of a sensing signal

The priority of the sensing signal is used by a core network and/or a radio access network to schedule resources of a plurality of sensing signals and/or to jointly schedule a sensing signal resource and a communication signal resource.
(2) A frequency domain bandwidth occupied by the sensing signal

A unit of the frequency domain bandwidth is at least one of hertz (Hz), subcarrier, resource block (RB), or bandwidth part (BWP).
(3) Time information of the sensing signal

The time information includes at least one of a time length, a time periodicity, time information of each periodicity sensing signal, a protection interval, burst duration, or a time interval. The protection interval is a time interval from a moment at which sending of a signal ends to a moment at which a latest echo signal of the signal is received. This parameter is directly proportional to a maximum sensing distance, for example, may be calculated by 2dmax, where dmax is the maximum sensing distance (a sensing requirement), for example, or a self-sent and self-received sensing signal. The burst duration is inversely proportional to velocity resolution (a sensing requirement). This parameter is a time span of the sensing signal, and is mainly used to calculate a Doppler frequency deviation. This parameter may be calculated by c/2/delta_v/fc, where delta_v is velocity resolution, and fc is a signal carrier frequency or a center frequency of a signal. The time interval is a time interval between two neighboring sensing signals. This parameter may be calculated by c/2/fc/v_range, where v_range is a maximum velocity minus a minimum velocity (a sensing requirement). When the sensing signal is a periodic signal, the time interval is equal to a time periodicity.
(4) A transmit power of the sensing signal
(5) Waveform quality of the sensing signal

The waveform quality of the sensing signal includes waveform quality such as a side lobe (for example, a low Doppler side lobe or a short distance side lobe) of a sensing signal waveform and/or a peak-to-average ratio.
(6) A quantity of transmit ports of the sensing signal
(7) A beam width of the sensing signal

The beam width of the sensing signal refers to an angle between two specified power points of a beam. For example, in radar meteorology, a beam width is defined as an angle between two half power points of a beam. The beam width of the sensing signal includes a vertical beam width and/or a horizontal beam width.
(8) Frequency domain continuity of the sensing signal

The frequency domain continuity of the sensing signal means that a sensing signal bandwidth is a frequency domain continuous bandwidth or discontinuous bandwidth.
(9) A type of the sensing signal

Classification may be performed based on a multiplexing reference signal, a sensing-specific reference signal, and a multiplexing data signal; or may be performed based on a configuration manner of the sensing signal. For example, sensing signals configured only by using an RRC message are of one type, sensing signals configured only by using DCI are of one type, and sensing signals configured by using both the RRC message and the DCI are of one type.
(10) An algorithm gain adjustment of the sensing signal

The algorithm gain adjustment of the sensing signal means that a sensing signal parameter may be dynamically adjusted or remain unchanged with an algorithm gain. Usually, the foregoing sensing signal parameter is calculated based on a reference algorithm (such as Fast Fourier Transform (FFT)/Inverse Fast Fourier Transform (IFFT)) or an algorithm used by a network function instance generating sensing QoS information. If an algorithm of the sensing measurement quantity or an algorithm of transforming the sensing measurement quantity to a sensing result is not common, a gain factor thereof is defined based on performance of the corresponding algorithm, that is, compared with a performance gain of the foregoing reference algorithm, the parameter is adjusted based on the gain factor. For example, resolution estimated for DOA is improved by using Multiple Signal Classification (MUSIC), and the gain factor is ½. In this case, the corresponding sensing signal bandwidth or the beam width parameter is multiplied by ½ to adapt to requirements of different algorithms on the sensing signal bandwidth or the beam width.

In some embodiments, the sensing data transmission QoS parameter includes at least one of the following:
(1) A priority of sensing data

The priority of the sensing data is used to schedule a radio resource.
(2) A type of the sensing data

The sensing data includes at least the measurement result of the sensing measurement quantity generated by measuring the sensing signal. Different from an existing communication service, a quantity of sensing measurement quantities (that is, how many sensing measurement quantities need to be reported, for example, an RSRP and an RSSI of signal strength sensing measurement are reported), a size (that is, a data length of each sensing measurement quantity, where if there are a plurality of sensing measurement quantities, the size may be a total data length of the plurality of sensing measurement quantities), and a report time and/or interval (that is, a time and time interval of reporting sensing data (for example, when reporting is performed for a plurality of times, a network may configure an initial report time and a report periodicity)) are all determined under an indication of network function configuration information. Therefore, the network already learns of a characteristic of the sensing data. If the sensing QoS information indicates a data type, it helps a core network or a radio access network side optimize a resource configuration of sensing data transmission and reduce overheads. A sensing data type may be defined based on a size and/or a transmission time (for example, transmission is performed in a slot of a subframe of a frame) of sensing data that needs to be transmitted each time and/or a transmission time interval (for example, transmission is performed every 10 frames), for example, a specified time interval + a specified data size (for example, X bytes of data is transmitted every 200 ms), a specified time interval (indicating a maximum data burst volume, without specifying a specific data size of each time of transmission), a specified data size (indicating a minimum data burst time, without specifying a specific data interval time length of each time of transmission).
(3) A transmission resource type of the sensing data

In the integration of sensing, a resource needs to satisfy both communication and sensing requirements. A resource type may be defined based on a relationship between sensing and communication resources, for example, a sensing-specific resource and a sensing communication shared resource. In some embodiments, a resource type may be defined based on a requirement on a final transmission effect, for example, delay-critical, non-delay-critical, a guaranteed bit rate, a non-guaranteed bit rate, a guaranteed packet error rate, and/or a non-guaranteed packet error rate.
(4) A packet delay budget in sensing data transmission

The packet delay budget in sensing data transmission defines an upper limit of a tolerable delay for a data packet transmitted between a sensing node (which may be a base station and/or a UE) and a sensing function (SF) instance.
(5) Delay variation in sensing data transmission

The delay variation in sensing data transmission defines maximum tolerable delay variation when a data packet is transmitted between the sensing node and the SF, especially when the sensing function (SF) requires joint processing on sensing measurement quantities of a plurality of base stations or UEs. The packet delay budget and the delay variation jointly determine a start time at which the SF calculates the sensing result.
(6) A packet error rate in sensing data transmission

The packet error rate in sensing data transmission defines an upper limit of the packet error rate. A data packet has been processed by a link layer at a transmit end, but the upper limit of the rate of the upper layer has not been submitted by a corresponding receive end. A function of the packet error rate is to enable a network to configure a proper link layer parameter (for example, a HARQ configuration of RLC).
(7) A burst time of sensing data

The burst time of the sensing data defines a time length of two times of data sending, and is limited only to a resource type of one or a combination of a delay-critical guaranteed rate and a guaranteed packet error rate.
(8) A burst volume of the sensing data

The burst volume of the sensing data defines a data volume, and is applicable only to a resource type of one or a combination of a delay-critical guaranteed rate and a guaranteed packet error rate.

The sensing data includes a measurement result of the sensing measurement quantity.

For example, in Embodiment 1, the sensing QoS information includes at least one of the following:
(1) A sensing QoS type A (a sensing service QoS parameter), including at least one of the following:
a sensing resource type;
a maximum sensing response time;
lowest sensing service availability;
a sensing service area;
lowest sensing accuracy at a confidence level X;
a sensing service priority;
sensing resolution; or
an update frequency of the sensing result.
(2) A sensing QoS type B (a sensing measurement quantity QoS parameter), including at least one of the following:
a minimum periodicity and/or quantity of sensing signals that corresponds to a measurement result of the sensing measurement quantity;
a longest time of measuring the sensing measurement quantity;
a longest time interval of reporting the measurement result of the sensing measurement quantity;
whether to report tag information when reporting the measurement result of the sensing measurement quantity, where the tag information includes at least one of a time tag, a frequency tag, a geolocation tag, a UE tag, a resource tag of a sensing signal, and a quality tag of the sensing signal; or
a constraint of sensing measurement.
(3) A sensing QoS type C (a sensing signal QoS parameter), including at least one of the following:
a priority of a sensing signal;
a minimum frequency domain total bandwidth occupied by the sensing signal;
a maximum repetition periodicity of the sensing signal, referring to a maximum length of time for which the sensing signal can be repeated;
a minimum time domain length occupied by the sensing signal, referring to a minimum time domain time occupied by a sensing signal;
a minimum transmit power of the sensing signal;
lowest quality of a sensing signal waveform, indicating that a side lobe (for example, a Doppler side lobe level is not higher than a value, and a distance side lobe is not higher than a value) and a peak-to-average ratio of the sensing signal waveform are not higher than waveform quality of a value;
a minimum quantity of transmit ports of the sensing signal;
a maximum beam width of the sensing signal, referring to an angle between two specified power points of a beam, where for example, in radar meteorology, a beam width is defined as an angle between two half power points of a beam; or frequency domain continuity of the sensing signal.
(4) A sensing QoS type D (sensing data transmission), including at least one of the following:
a lowest priority of sensing data;
a type of the sensing data;
a transmission resource type of the sensing data;
a maximum packet delay budget in sensing data transmission;
maximum delay variation in sensing data transmission;
a maximum packet error rate in sensing data transmission;
a shortest data burst time of the sensing data; or
a maximum data burst volume of the sensing data.

### 2. Non-Classification Definition

In some embodiments, the sensing QoS information includes at least one of the following:
a sensing resource type;
a sensing response time;
sensing service availability;
a sensing service area;
sensing accuracy;
a periodicity and/or quantity of sensing signals that corresponds to a measurement result of the sensing measurement quantity;
a time of measuring the sensing measurement quantity;
a time interval of reporting the measurement result of the sensing measurement quantity;
whether to report tag information when reporting the measurement result of the sensing measurement quantity, where the tag information includes at least one of a time tag, a frequency tag, a geolocation tag, a UE tag, a resource tag of a sensing signal, or a quality tag of the sensing signal;
a constraint of sensing measurement;
a sensing service priority;
sensing resolution; or
an update frequency of the sensing result.

In some embodiments, the sensing QoS information further includes at least one of the following:
a priority of a sensing signal;
a frequency domain total bandwidth occupied by the sensing signal;
a repetition periodicity of the sensing signal;
a time domain length occupied by the sensing signal;
a transmit power of the sensing signal;
waveform quality of the sensing signal;
a quantity of transmit ports of the sensing signal;
a beam width of the sensing signal;
frequency domain continuity of the sensing signal;
a type of the sensing signal;
an algorithm gain adjustment of the sensing signal;
a priority of sensing data;
a type of the sensing data;
a transmission resource type of the sensing data;
a packet delay budget in sensing data transmission;
delay variation in sensing data transmission;
a packet error rate in sensing data transmission;
a burst time of the sensing data; or
a burst size of the sensing data, where
the sensing data includes a measurement result of the sensing measurement quantity.

For example, in Embodiment 2, the sensing QoS information includes at least one of the following:
a sensing resource type;
a maximum sensing response time;
lowest sensing service availability;
a sensing service area;
lowest sensing accuracy at a confidence level X;
a sensing service priority;
sensing resolution;
an update frequency of a sensing result;
a minimum periodicity and/or quantity of sensing signals that corresponds to a measurement result of the sensing measurement quantity;
a longest time of measuring the sensing measurement quantity;
a longest time interval of reporting the measurement result of the sensing measurement quantity;
whether to report tag information when reporting the measurement result of the sensing measurement quantity, where the tag information includes at least one of a time tag, a frequency tag, a geolocation tag, a UE tag, a resource tag of a sensing signal, or a quality tag of the sensing signal; or
a constraint of sensing measurement.

Further, in some embodiments, the sensing QoS information further includes at least one of the following:
a priority of a sensing signal;
a minimum frequency domain total bandwidth occupied by the sensing signal;
a maximum repetition periodicity of the sensing signal, referring to a maximum length of time for which the sensing signal can be repeated;
a minimum time domain length occupied by the sensing signal, referring to a minimum time domain time occupied by a sensing signal;
a minimum transmit power of the sensing signal;
lowest quality of a sensing signal waveform, indicating that a side lobe (for example, a Doppler side lobe level is not higher than a value, and a distance side lobe is not higher than a value) and a peak-to-average ratio of the sensing signal waveform are not higher than waveform quality of a value;
a minimum quantity of transmit ports of the sensing signal;
a maximum beam width of the sensing signal, referring to an angle between two specified power points of a beam, where for example, in radar meteorology, a beam width is defined as an angle between two half power points of a beam;
frequency domain continuity of the sensing signal;
a lowest priority of sensing data;
a type of the sensing data;
a transmission resource type of the sensing data;
a maximum packet delay budget in sensing data transmission;
maximum delay variation in sensing data transmission;
a maximum packet error rate in sensing data transmission;
a shortest data burst time of the sensing data; or
a maximum data burst volume of the sensing data.

In the foregoing embodiment, a value of at least one parameter in the sensing QoS information is indicated by using a value with a minimum requirement; and/or a value of at least one parameter in the sensing QoS information is indicated in an interval manner. For example, that the QoS parameter of the sensing measurement quantity is indicated by using the value with the minimum requirement may mean that a measurement result of each sensing measurement quantity is obtained by measuring and calculating at least N sensing signals. A longest time interval of reporting the measurement result of the sensing measurement quantity is X ms.

In this embodiment of this application, the sensing QoS information is defined more comprehensively from a plurality of dimensions, and the relationship between the sensing parameters are described. The sensing QoS information is decoupled from the sensing service, and has better representativeness with an increase of sensing services, enabling an interaction of a QoS related parameter among nodes in an end-to-end sensing process.

As can be learned, in the foregoing embodiment, the sensing QoS information includes a plurality of parameters. Sending a large quantity of parameters is not conducive to communication efficiency. In this embodiment of this application, one Sensing quality identifier (SQI) may be used to indicate one sensing QoS information parameter combination, in other words, the sensing QoS information is indicated by using a value of the sensing quality identifier, and different values of the sensing quality identifier correspond to different sensing QoS information parameter combinations.

For example, in Embodiment 3, it is assumed that a classification-based definition manner is used for the sensing QoS information. Based on this, a definition of a sensing quality identifier (SQI) is shown in Table 4:

TABLE 4
Mappings between standard SQIs and QoS parameters

| | Sensing | Sensing | Sensing | Sensing | |
|---|---|---|---|---|---|
| SQI | QoS | QoS | QoS | QoS | |
| value | type A | type B | type C | type D | Example service |
| 10 | 5 | 10 | 3 | 2 | Traffic monitoring |
| 20 | 10 | 3 | 7 | N/A | Respiratory monitoring |

As can be learned from Table 4, when the SQI value is equal to 10, the sensing QoS information includes: the sensing QoS type A, the sensing QoS type B, the sensing QoS type C, and the sensing QoS type D. The sensing QoS type A being equal to 5 corresponds to one parameter combination of the sensing QoS type A. Similarly, the sensing QoS type B being equal to 10 also corresponds to one parameter combination of the sensing QoS type A. The rest may be deduced by analogy. When the SQI value is equal to 20, the sensing QoS information includes: the sensing QoS type A, the sensing QoS type B, and the sensing QoS type C.

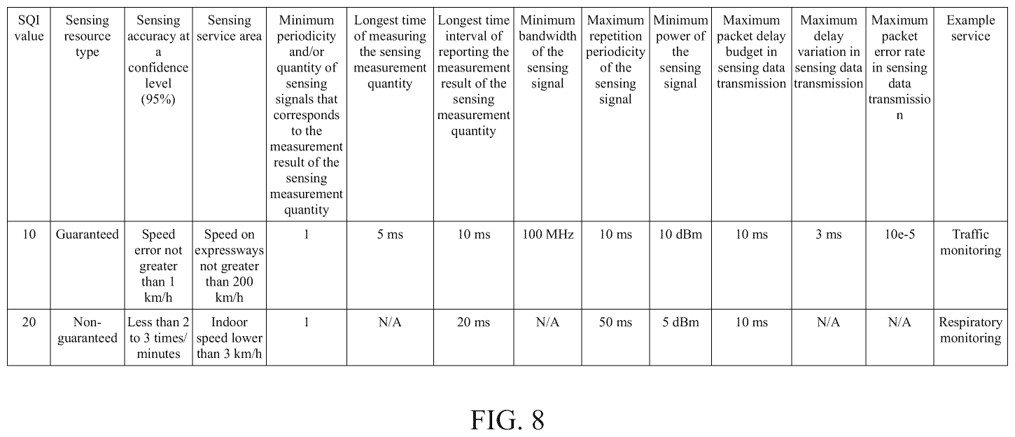

If the classification-based definition manner is not used for the sensing QoS information, the sensing QoS type A/B/C/D in Table 4 is a QoS parameter combination in the sensing QoS information. A definition of a sensing quality identifier (SQI) is shown in FIG. 8.

In this embodiment of this application, the SQI may have another name, for example, a sensing service level. The values in the table are merely examples, and may be other values. The parameters in Table 4 and FIG. 8 are merely used as instances, and a combination of one or more of the parameters may be used.

In some embodiments, the sensing QoS information may be indicated by using service level indication information, and different service level indication information corresponds to different sensing QoS information parameter combinations.

In this embodiment of this application, the sensing QoS implementation method further includes: The first device sends information about the determined sensing measurement quantity and/or the determined configuration information of the sensing measurement quantity to a sensing node. The sensing node may be a terminal or a base station.

In this embodiment of this application, the sensing QoS implementation method further includes: The first device performs at least one of the following operations based on the sensing QoS information:
(1) Determine a sensing link.

The sensing link may be at least one of the following: a Uu link (a base station performs sending and a UE performs receiving, or a base station performs receiving and a UE performs sending), a sidelink (one UE performs sending and another UE performs receiving), an echo link (a base station performs both sending and receiving, and a UE performs both sending and receiving), or a transceiver link between base stations (one base station performs sending and another base station performs receiving) (note: the foregoing description is provided by using an example of one transmit end and one receive end, which may be expanded to a plurality of transmit ends and receive ends).
(2) Determine a sensing manner.

The sensing manner includes at least one of the following: The base station performs sending and the UE performs receiving, the base station performs receiving and the UE performs sending, receiving and sending are performed between UEs, the base station performs both sending and receiving, and the UE performs both sending and receiving, or receiving and sending are performed between base stations.
(3) Determine a sensing signal.

The sensing signal is selected based on a received sensing request and/or algorithm. The sensing signal may be an existing reference signal (as shown in Table 5), a newly defined reference signal, or a data signal (for example, a non-pilot signal on a PDSCH or a PUSCH) in a communication process. Therefore, one or more of the foregoing need to be selected as sensing signals.

TABLE 5
Existing reference signals that may be used as sensing signals

| NR Down-Link RS | NR Up-Link RS | NR Sidelink RS |
|---|---|---|
| PDSCH-DMRS | PUSCH-DMRS | PSSCH-DMRS |
| PDCCH-DMRS | PUCCH-DMRS | PSCCH-DMRS |
| PBCH-DMRS | PTRS | PSSCH-PTRS |
| PT-RS | SRS | PSBCH-DMRS |
| CSI-RS | | CSI-RS |
| RIM-RS | | |
| P-RS | | |

In Table 5, there are new radio downlink remote sensing (NR Down-Link RS), new radio uplink remote sensing (NR UP-Link RS), and new radio sidelink remote sensing (NR Sidelink RS), which include a physical downlink shared channel-demodulation reference signal (PDSCH-DMRS), a physical broadcast channel-demodulation reference signal (PBCH-DMRS), a physical uplink control channel-demodulation reference signal (PUCCH-DMRS), a physical downlink control channel-demodulation reference signal (PDCCH-DMRS), a physical uplink shared channel-demodulation reference signal (PUSCH-DMRS), physical sidelink control channel-demodulation reference signal (PSSCH-DMRS), a sidelink secondary synchronization signal-demodulation reference signal (SSSS-DMRS), a phase tracking reference signal (PT-RS), a channel state information reference signal (CSI-RS), a remote interference management reference signal (Remote Interference management Reference Signal, RIM-RS), a positioning reference signal (P-RS), a phase tracking reference signal (PTRS), and a channel sounding reference signal (SRS).
(4) Determine configuration information of the sensing signal.

In some embodiments, the configuration information of the sensing signal includes at least one of the following:
(1) frequency domain information of a sensing signal, including at least one of a frequency domain start position, a bandwidth, or the like, where the bandwidth is inversely proportional to distance resolution, and may be obtained by c/2/delta_d, delta_d is the distance resolution, and a potential configuration manner is performing configuration by using DCI;
(2) time domain information of the sensing signal, including at least one of a time domain start position, a time domain length, a time periodicity, or the like, and a potential configuration manner is performing configuration by using DCI;
(3) a port number of the sensing signal, indicating the port number used to send the sensing signal;
(4) effective indication information configured for the sensing signal, including at least one of becoming effective immediately after configuration, becoming effective when specified downlink control information (DCI) is received, and so on;
(5) a time domain distribution type of the sensing signal, including one of continuous distribution of a plurality of symbols, distribution at a specified quantity of symbols, or the like, where a potential configuration manner is performing configuration by using an RRC message;
(6) a frequency domain distribution type of the sensing signal, including one of continuous distribution of a plurality of subcarriers, distribution at a specified quantity of subcarriers, or the like, where a potential configuration manner is performing configuration by using an RRC message;
(7) waveform information, for example, OFDM, SC-FDMA, OTFS, a frequency modulation continuous waveform FMCW, a pulse signal, or the like;
(8) a subcarrier spacing, where for example, the subcarrier spacing of an OFDM system is 30 KHz;
(9) a signal transmit power or an EIRP, where for example, a value is taken every 2 dBm from −20 dBm to 23 dBm;
(10) a direction of a signal, for example, a direction of a sensing signal or beam information; and
(11) beam information or a QCL relationship, where for example, the sensing signal includes a plurality of resources, and each resource corresponds to one SSB QCL, and the QCL includes a type A, B, C, or D.
(5) Determine a sensing node.

A base station and/or UE participating in sensing is selected.
(6) Trigger establishment and/or modification of a sensing data transmission channel.
(7) Determine configuration information of sensing data transmission.

In this embodiment of this application, the sensing QoS implementation method further includes: The first device sends one or more of information about the determined sensing link, information about the determined sensing manner, information about the determined sensing signal, the determined configuration information of the sensing signal, and the determined configuration information of sensing data transmission to the sensing node.

The following describes the sensing QoS implementation method in this application by using an example in which the first device is a sensing function instance, a base station, or a terminal.
1. The first device is a sensing function instance.

In some embodiments, that a first device obtains sensing QoS information includes:

The sensing function instance receives a sensing request; and
the sensing function instance obtains the required sensing QoS information based on sensing QoS information included in the sensing request.

In this embodiment of this application, if the sensing QoS information obtained by the sensing function instance from the sensing request satisfies a requirement, the sensing QoS information obtained from the sensing request is directly used as the required sensing QoS information. If the sensing QoS information obtained by the sensing function instance from the sensing request does not satisfy a requirement, the required sensing QoS information may further be generated based on the sensing QoS information obtained from the sensing request.

For example, if the sensing request includes only the sensing service QoS information, the sensing function instance determines the required sensing measurement quantity QoS parameter based on the sensing service QoS parameter. In some embodiments, if the sensing request includes only an identifier of a sensing service requester, the sensing function may obtain sensing service QoS information corresponding to the service requester based on a service level agreement (SLA) that is signed in advance.

In some embodiments, after the first device determines the at least one of the sensing measurement quantity or the configuration information of the sensing measurement quantity based on the sensing QoS information, the method further includes:
The sensing function instance receives a measurement result of the sensing measurement quantity sent by a sensing node;
the sensing function instance generates a sensing result based on the measurement result; and
the sensing function instance sends a sensing request response, where the sensing request response includes the sensing result.

In this embodiment of this application, the sensing function instance may respond to the sensing request based on the sensing service QoS parameter.

In this embodiment of this application, the second device is a base station, and that the first device sends the sensing QoS information to the second device includes:

The sensing function instance sends the sensing QoS information to the base station, and the base station determines the at least one of the sensing measurement quantity or the configuration information of the sensing measurement quantity based on the sensing QoS information.

In this embodiment of this application, the second device is a terminal, and that the first device sends the sensing QoS information to the second device includes:

The sensing function instance sends the sensing QoS information to the terminal, and the terminal determines the at least one of the sensing measurement quantity or the configuration information of the sensing measurement quantity based on the sensing QoS information.

In some embodiments, that the first device determines at least one of the sensing measurement quantity or configuration information of the sensing measurement quantity based on the sensing QoS information includes:
The sensing function instance determines the configuration information of the sensing measurement quantity based on the sensing QoS information, and sends a negotiation request for the configuration information of the sensing measurement quantity to the base station, or sends a negotiation request for the configuration information of the sensing measurement quantity and the sensing QoS information to the base station;
the sensing function instance receives a negotiation result sent by the base station, where the negotiation result includes one of the following: the base station accepts the configuration information of the sensing measurement quantity, or the base station does not accept the configuration information of the sensing measurement quantity and a reason of nonacceptance and/or configuration information of a sensing measurement quantity suggested by the base station; and
the sensing function instance generates configuration information of a final sensing measurement quantity based on the negotiation result.
2. The first device is a base station.

That the first device obtains sensing QoS information includes: The base station receives the sensing QoS information sent by the sensing function instance.

Therefore, the base station determines at least one of the sensing measurement quantity or the configuration information of the sensing measurement quantity based on the sensing QoS information.
3. The first device is a terminal.

That the first device obtains sensing QoS information includes: The terminal receives the sensing QoS information sent by the sensing function instance.

Therefore, the terminal determines at least one of the sensing measurement quantity or the configuration information of the sensing measurement quantity based on the sensing QoS information.

The following describes the sensing QoS implementation method in this application by using examples with reference to specific embodiment.

### Embodiment 4: A Sensing QoS Implementation Method for a Classification Definition Manner Based on a 5G Protocol Procedure

In this embodiment, based on a 5G protocol, UE user plane QoS interaction procedure expansion supports a sensing QoS interaction, applicable to a case in which a UE serves as a sensing node to receive a sensing signal and perform measurement (for example, the base station sends a sensing signal, and the UE receives the sensing signal, the UE sends and receives a sensing signal, or a sensing signal is sent and received between UEs).

A brief description of the sensing QoS implementation method is as follows:

Step 1: A sensing function (sensing function, SF, a network function responsible for receiving a sensing request and providing a sensing result, which may have another name) instance receives the sensing request, where the sensing request includes but is not limited to one or more of the following information:
(1) A Sensing QoS type

The sensing QoS type may be:
Type I: a best effort type. To be specific, if the sensing result cannot satisfy a QoS indicator requirement, the sensing result still needs to be fed back, but it needs to indicate that requested QoS has not been satisfied. If no sensing result has been obtained, a failure cause is fed back.
Type II: a multiple QoS type. To be specific, QoS indicator requirements corresponding to a plurality of QoS classes are included. If the sensing result does not satisfy the strictest QOS indicator requirement, the SF initiates a sensing procedure again to try to satisfy a lower QoS indicator requirement, until one QoS indicator requirement is satisfied. If the most lenient QoS indicator requirement is still not satisfied, no sensing result is fed back, and only a failure cause is fed back.
Type III: an assured type, the strictest sensing QoS type. If the sensing result cannot satisfy the QoS indicator requirement, no sensing result is fed back, and only a failure cause is fed back.
(2) A sensing service type

The sensing service type may be defined in the following manners:
(a) The sensing service type may be defined based on requirements on a bandwidth and a time domain duration delay of the sensing signal. For example, Type I is a large bandwidth continuous sensing service (the sensing result is provided a plurality of times based on a specified time or a geographical location), Type II is a large bandwidth one-time sensing service (the sensing result is provided once), Type III is a small bandwidth continuous sensing service, and a Type IV is a small bandwidth one-time sensing service.
(b) The sensing service type is defined based on requirements on a delay and a bandwidth of sensing data transmission. For example, Type I is a large bandwidth sensing service (sensing data transmission has a relatively high requirement on the bandwidth or a guaranteed bit rate), Type II is a low-latency sensing service (sensing data transmission requires a relatively low packet delay budget), Type III is a large bandwidth and low-latency sensing service (having the foregoing two requirements), and Type IV is a transmission quality non-critical sensing service (having no particular requirement on sensing data transmission quality).
(c) The sensing service type may be defined accordingly based on a quality of service type or class (QOS class) of a sensing service.
(d) The sensing service type may be defined based on a sensing physical range and a real-time performance requirement. For example, for Type I, a sensing range is large and a real-time performance requirement is high (Delay Critical LSS); for Type II, the sensing range is large and the real-time performance requirement is low (LSS); for Type III, the sensing range is small and the real-time performance requirement is low (Delay Critical SSS); and for Type IV, the sensing range is small and the real-time performance requirement is low (SSS).
(3) A response time type

The response time type may include one or more of the following types based on a type of a response time:

A no delay type: The SF immediately feeds back a sensing result of a sensing target; and if there is no sensing result, feeds back failure information, and may trigger a sensing procedure, used to respond to a subsequent sensing request.

A low delay type: Compared with accuracy, a response time requirement is preferentially satisfied. The SF should return a current sensing result at a lowest delay.

A delay insensitive type: Compared with a response time, an accuracy requirement is preferentially satisfied. The SF may feed back a sensing result at a delay, until a required sensing QoS requirement is satisfied.
(4) A sensing object

The sensing object may be classified into per object (a sensing service using a sensing target as the sensing object, for example, using a UE as a target) and per area (a sensing service using a geographic area as the sensing object, for example, an airport area).
(5) A quality of service requirement of the sensing service

The quality of service requirement of the sensing service includes but is not limited to at least one of sensing accuracy, sensing resolution, a sensing error, a sensing range, a sensing delay, a detection probability, or a false alarm probability. Based on different sensing services, the sensing resolution may be distance resolution, imaging resolution, moving velocity resolution, angle resolution, respiratory resolution, frequency resolution, or rainfall resolution. Based on different sensing services, the sensing error may be a distance error, an imaging error, a moving speed error, a respiratory rate error, recognition accuracy, or a rainfall error in a case of satisfying a confidence level.
(6) Sensing QoS information, including at least one of the following: a sensing service QoS parameter, a sensing measurement quantity QoS parameter, a sensing signal QoS parameter, or a sensing data transmission QoS parameter. If the sensing request received by the SF does not include a type of sensing QoS information, the SF may generate the required type of sensing QoS information based on the received sensing QoS information.
Step 2: The SF sends a message including a sensing data transmission QoS parameter to a Session Management Function (SMF), where in addition to the sensing data transmission QoS parameter, the message may further include a UE identifier used for sensing measurement and the like.

In this step, the SF may interact with an AMF to obtain an SMF.
Step 3: The SF sends a message including sensing QoS information (for example, including a sensing signal QoS parameter) to a base station (in a manner of direct sending or sending through another core network function such as the AMF), where in addition to the sensing QoS information, the message may further include one or more of a UE identifier and a selected sensing signal (for example, a PRS and/or an SRS).
Step 4: If a sensing measurement node is a UE, and the configuration information of the sensing measurement quantity is determined by the UE based on information such as a capability, the SF further needs to send sensing QoS information (for example, including a sensing measurement quantity QoS parameter) to the UE. If the configuration information of the sensing measurement quantity is determined by a base station, step 4 and step 3 may be combined, and the SF sends sensing QoS information (for example, including a sensing quality of service QoS parameter and/or a sensing measurement quantity QoS parameter and/or a sensing signal QoS parameter) to the base station. In addition to the sensing QoS information, the message may further include one or more of a UE identifier, an identifier of a target network function receiving a measurement result, a sensing measurement quantity, or a sensing measurement quantity group identifier.

Note: Steps 2, 3, 4 do not have a sequential relationship, and may be performed simultaneously or in any sequence.
Step 5: The SF sends sensing configuration information to a UE participating in sensing, where the sensing configuration information is, for example, a sensing measurement quantity such as a sensing manner or an RSRP, or a sensing measurement quantity report manner (that is, a sensing data type, for example, a specified time+a specified size). If the sensing measurement node in step 4 is a UE, steps 4 and 5 may be combined.
Step 6: The UE completes a PDU session establishment or modification procedure based on a received message.

The establishment procedure is used as an example, related information is briefly described as follows:

The UE initiates a PDU session establishment request by using a NAS message. The request message includes one or more of the UE identifier (such as an SUPI), information indicating that the PDU is used for sensing data transmission, and the received information of the SF.

The AMF selects the SMF based on the PDU session establishment request, and sends a creation message through ports of the AMF and the SMF. The SMF sends a creation response. If PDU session authentication or authorization is required, related information exchange also needs to be performed.

The SMF selects a UPF and/or the information about the SF received in step 2 based on the received information/context of the creation request, and sends a used QoS control parameter such as a Packet Detection Rule (PDR) to the UPF through N4 interface session establishment (session establishment) or session modification. The PDR parameter includes at least one of an ID identifying an N4 session associated with the PDR, a unique ID identifying the rule, a sequence of determining detection information to which all rules are applied, data packet detection information (including a QoS flow ID, a UE IP address, CN tunnel information, and the like), a necessary forwarding behavior operation (for example, forwarding to the sensing function), a necessary measurement behavior (for example, a sensing packet transmission delay or a packet error rate), or the like. The SMF sends, through the AMF and an (R)AN (that is, the NAS message), QoS parameter information such as the QoS rule used by the UE on the established PDU session, and further needs to send a QoS parameter at a QoS flow level if the QoS flow is related to the QoS rule. The QoS rule may be defined based on an existing QoS rule. In this case, QFI needs to be classified into sensing QFI and communication QFI. A mapping relationship between the QoS rule and the sensing QFI may be provided in an explicit manner (for example, the mapping relationship is explicitly provided for the UE in the PDU session establishment/modification process), an implicit manner (for example, reflective QoS), and the like. The SMF sends, through the AMF and an N2 interface between the AMF and the (R)AN, QOS parameter information such as a QoS profile used by a gNB on the established PDU session.
Step 7: The base station determines configuration information of the selected sensing signal based on the sensing QoS information received in step 3, and sends the configuration information of the sensing signal to the UE.

Note: Step 6 and step 7 are not in any particular sequence.
Step 8: The base station sends a sensing signal, and the UE receives and measures the sensing signal.
Step 9: The UE reports a measurement result of a sensing measurement quantity of the sensing signal through the foregoing sensing PDU session, and the UPF forwards the measurement result of the sensing measurement quantity to the SF according to a PDR.
Step 10: The SF generates a sensing result based on the measurement result of the sensing measurement quantity, and responds to the sensing request.

### Embodiment 5: A Sensing QoS Implementation Method in a Sensing Manner in which a UE A Sends a Sensing Signal and a UE B Receives the Sensing Signal

Embodiment 4 describes an interaction procedure in which the base station sends the sensing signal and the UE receives and measures the sensing signal. This embodiment describes a procedure of the sensing QoS implementation method in which the UE A sends the sensing signal and the UE B receives and measures the sensing signal.
Step 1 is the same as step 1 in Embodiment 4, and details are not described herein again.
Step 2: An SF sends sensing QoS information (for example, including a service QoS parameter and/or a sensing measurement quantity QoS parameter and/or a sensing signal QoS parameter) to at least one of the UE A or the UE B.
Step 3: The SF sends sensing QoS information (for example, including a sensing measurement quantity QoS parameter and/or a sensing data transmission QoS parameter) to a serving base station of the UE B and/or an AMF or an SMF on which the UE is located.

Note: Step 2 and step 3 are not in any particular sequence.
Step 4: Corresponding to step 2, the UE A and/or the UE B determines at least one of the following based on the received sensing QoS information: a sensing signal, configuration information of the sensing signal, a sensing measurement quantity, or configuration information of the sensing measurement quantity.
Step 5: The UE A requests a base station for a sidelink sending resource (where the request may be carried in a SidelinkUEinformationNR message), where the request includes a required time frequency resource, and the required time frequency resource is obtained based on the information in step 3. Similarly, the UE B requests for a required receiving resource.
Step 6: The base station allocates the sending resource and the receiving resource respectively to the UE A and the UE B.
Step 7: The UE A sends the sensing signal, and the UE B receives and measures the sensing signal.
Step 8: Corresponding to step 3, the SMF, the AMF, and the base station establish a sensing data transmission channel (for example, a PDU session) for the UE B based on the sensing measurement quantity QoS parameter and/or the sensing data transmission QoS parameter.

Note: Step 8 and steps 4 to 7 are not in sequence, provided that step 8 is after step 3 and before step 9.
Step 9: The UE B reports a measurement result of the sensing measurement quantity to the SF through the sensing data transmission channel (for example, the PDU session).
Step 10: The SF generates a sensing result based on the measurement result, and responds to the sensing request.

### Embodiment 6: A Sensing QoS Implementation Method Primarily Based on a Sensing Function (SF)

A sensing QOS (QOS in this embodiment may be a classified QoS definition or a unclassified definition) interaction method primarily based on sensing function (SF) means that the SF is at least responsible for selecting a sensing measurement quantity and/or generating configuration information of a sensing measurement quantity. When the configuration information of the sensing measurement quantity is configured only by using an RRC message, it is more appropriate for the SF to negotiate with a base station on the configuration information of the sensing measurement quantity. If per TTI is configured only by using DCI, it is generally considered that real-time performance of the SF cannot satisfy the configuration of per TTI yet.

On a Uu link, an interaction procedure of the sensing QoS implementation method is briefly described below:

For step 1, refer to step 1 in Embodiment 4.
Step 2: An SF determines a sensing measurement quantity based on received sensing QoS information or sensing QoS information generated by the SF, and determines at least one of a sensing link, a sensing manner, a sensing signal, or a sensing node. In some embodiments, the SF sends a sensing manner to a UE.
Step 3a: One possibility is that based on the foregoing information determined by the SF, the SF sends the sensing QoS information (for example, including a sensing measurement quantity QoS parameter) to a base station.
Step 3b: In addition to step 3a, another possibility is that the SF determines configuration information of the sensing measurement quantity, and negotiates with the base station to request for the configuration information of the sensing measurement quantity.
Step 3c: In addition to steps 3a and 3b, another possibility is that the SF sends the information in steps 3a and 3b to the base station.
Step 4a: Corresponding to step 3a, the base station determines the configuration information of the sensing measurement quantity based on the sensing QoS information.
Step 4b: Corresponding to step 3b, the base station determines, based on the requested configuration information of the sensing measurement quantity and a resource scheduling status, whether to accept the request for the configuration information of the sensing measurement quantity. If the base station accepts the request for the configuration information of the sensing measurement quantity, the base station feeds back acceptance to the SF. If the base station does not accept the request for the configuration information of the sensing measurement quantity, the base station feeds back a reason, so that the SF requests for the configuration information of the sensing measurement quantity again. In some embodiments, if the base station does not accept the request for the configuration information of the sensing measurement quantity, the base station feeds back suggested configuration information of the sensing measurement quantity and/or a reason of not accepting the request.
Step 4c: Corresponding to step 3c, the base station determines, based on the requested configuration information of the sensing measurement quantity, the sensing QoS information, and/or the resource scheduling status, whether to accept the request for the configuration information of the sensing measurement quantity. If the base station does not accept the request for the configuration information of the sensing measurement quantity, the base station feeds back acceptance to the SF. If the base station does not accept the request for the configuration information of the sensing measurement quantity, the base station feeds back the suggested configuration information of the sensing measurement quantity and/or the reason of not accepting the request. If the base station does not accept the request for the configuration information of the sensing measurement quantity, the base station feeds back a reason of nonacceptance.
Step 5a: Based on steps 3 and 4, if the SF negotiates with the base station to determine the configuration information of the sensing measurement quantity, the base station sends the configuration information of the sensing measurement quantity to the UE. A potential manner includes indicating the configuration information of the sensing measurement quantity by using an RRC radio resource control information element (radio resource control information elements). A potential configuration manner for the sensing signal includes a DCI-based configuration manner.
Step 5b: Based on steps 3 and 4, if the SF negotiates with the base station to determine the configuration information of the sensing measurement quantity, the SF sends the configuration information of the sensing measurement quantity to the UE.
Step 6: The base station sends a sensing signal, and the UE receives and measures the sensing signal; or the UE sends a sensing signal, and the base station receives and measures the sensing signal.
Step 7: The sensing node (the UE or the base station) receiving and measuring the sensing signal reports a measurement result of a sensing measurement quantity of the sensing signal to the SF, where the measurement result may be directly reported or may be forwarded to the SF through another network function instance.
Step 8: The SF performs processing based on the measurement result of the sensing measurement quantity to generate a sensing result, and responds to the sensing request based on a sensing service QoS parameter, that is, provides the sensing result.

The sensing QoS implementation method provided in this embodiment of this application may be performed by a sensing QoS implementation apparatus. In this embodiment of this application, the sensing QoS implementation apparatus provided in embodiments of this application is described by using an example in which the sensing QoS implementation apparatus performs the sensing QoS implementation method.

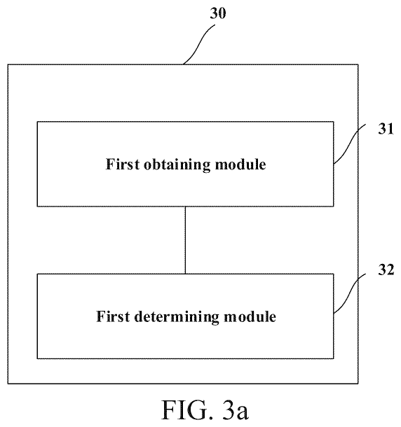

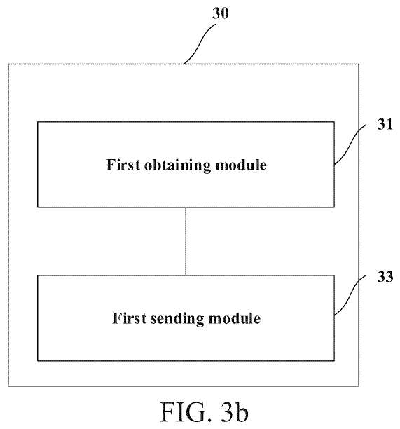

Refer to FIG. 3a and FIG. 3b. An embodiment of this application further provides a sensing QoS implementation apparatus 30, including:
a first obtaining module 31, configured to obtain sensing QoS information, where the sensing QoS information includes at least one of QOS information related to a sensing service or QoS information related to a sensing measurement quantity; and
a first determining module 32, configured to determine at least one of the sensing measurement quantity and configuration information of the sensing measurement quantity based on the sensing QoS information; or a first sending module 33, configured to send the sensing QoS information to a second device.

In this embodiment of this application, a first device can obtain the sensing QoS information, and determine the sensing measurement quantity and/or the configuration information of the sensing measurement quantity based on the sensing QoS information, and further can assist a sensing measurement node in measuring the sensing measurement quantity to obtain a sensing result, satisfying a sensing QoS requirement of a sensing service.

In this embodiment of this application, the configuration information of the sensing measurement quantity includes at least one of the following:
a sensing measurement quantity of sensing measurement;
a sensing signal on which sensing measurement needs to be performed;
a periodicity and/or quantity of sensing signals that corresponds to a measurement result of the sensing measurement quantity;
time domain and frequency domain resource information used to report the measurement result of the sensing measurement quantity;
a time interval of reporting the measurement result of the sensing measurement quantity;
tag information that needs to be reported when the measurement result of the sensing measurement quantity is reported; and
a constraint of sensing measurement.

In some embodiments, the sensing QOS information includes at least one of the following: a sensing service QoS parameter and a sensing measurement quantity QoS parameter.

In some embodiments, the sensing service QoS parameter includes at least one of the following:
a sensing resource type;
a sensing response time;
sensing service availability;
a sensing service area;
sensing accuracy;
a sensing service priority;
sensing resolution; and
an update frequency of the sensing result.

In some embodiments, the sensing measurement quantity QoS parameter includes at least one of the following:
a periodicity and/or quantity of sensing signals that corresponds to a measurement result of the sensing measurement quantity;
a time of measuring the sensing measurement quantity;
a time interval of reporting the measurement result of the sensing measurement quantity;
whether to report tag information when reporting the measurement result of the sensing measurement quantity, where the tag information includes at least one of a time tag, a frequency tag, a geolocation tag, a UE tag, a resource tag of a sensing signal, and a quality tag of the sensing signal; and
a constraint of sensing measurement.

In some embodiments, the sensing measurement quantity QoS parameter is a QoS requirement in terms of a sensing measurement quantity or a QoS requirement in terms of a sensing measurement quantity group.

In some embodiments, the sensing QoS information further includes at least one of the following: a sensing signal QoS parameter and a sensing data transmission QoS parameter.

In some embodiments, the sensing signal QoS parameter includes at least one of the following:
a priority of a sensing signal;
a frequency domain bandwidth occupied by the sensing signal, where a unit of the frequency domain bandwidth is at least one of hertz, subcarrier, resource block, and bandwidth part;
time information of the sensing signal, where the time information includes at least one of a time length, a time periodicity, time information of each periodicity sensing signal, a protection interval, burst duration, and a time interval;
a transmit power of the sensing signal;
waveform quality of the sensing signal;
a quantity of transmit ports of the sensing signal;
a beam width of the sensing signal;
frequency domain continuity of the sensing signal;
a type of the sensing signal; and
an algorithm gain adjustment of the sensing signal.

In some embodiments, the sensing data transmission QoS parameter includes at least one of the following:
a priority of sensing data;
a type of the sensing data;
a transmission resource type of the sensing data;
a packet delay budget in sensing data transmission;
delay variation in sensing data transmission;
a packet error rate in sensing data transmission;
a burst time of the sensing data; and
a burst size of the sensing data, where
the sensing data includes a measurement result of the sensing measurement quantity.

In some embodiments, the sensing QoS information includes at least one of the following:
a sensing resource type;
a sensing response time;
sensing service availability;
a sensing service area;
sensing accuracy;
a periodicity and/or quantity of sensing signals that corresponds to a measurement result of the sensing measurement quantity;
a time of measuring the sensing measurement quantity;
a time interval of reporting the measurement result of the sensing measurement quantity;
whether to report tag information when reporting the measurement result of the sensing measurement quantity, where the tag information includes at least one of a time tag, a frequency tag, a geolocation tag, a UE tag, a resource tag of a sensing signal, and a quality tag of the sensing signal;
a constraint of sensing measurement;
a sensing service priority;
sensing resolution; and
an update frequency of the sensing result.

In some embodiments, the sensing QoS information further includes at least one of the following:
a priority of a sensing signal;
a frequency domain total bandwidth occupied by the sensing signal;
a repetition periodicity of the sensing signal;
a time domain length occupied by the sensing signal;
a transmit power of the sensing signal;
waveform quality of the sensing signal;
a quantity of transmit ports of the sensing signal;
a beam width of the sensing signal;
frequency domain continuity of the sensing signal;
a type of the sensing signal;
an algorithm gain adjustment of the sensing signal;
a priority of sensing data;
a type of the sensing data;
a transmission resource type of the sensing data;
a packet delay budget in sensing data transmission;
delay variation in sensing data transmission;
a packet error rate in sensing data transmission;
a burst time of the sensing data; and
a burst size of the sensing data, where
the sensing data includes a measurement result of the sensing measurement quantity.

In some embodiments, the sensing QoS information is indicated by using a value of a sensing quality identifier, and different values of the sensing quality identifier correspond to different sensing QoS information parameter combinations; or
the sensing QoS information is indicated by using service level indication information, and different service level indication information corresponds to different sensing QoS information parameter combinations.

In some embodiments, a value of at least one parameter in the sensing QoS information is indicated by using a value with a minimum requirement; and/or
a value of at least one parameter in the sensing QoS information is indicated in an interval manner.

In some embodiments, the sensing QoS implementation apparatus 30 further includes:
a second sending module, configured to send information about the determined sensing measurement quantity and/or the determined configuration information of the sensing measurement quantity to a sensing node.

In some embodiments, the sensing QoS implementation apparatus 30 further includes:
a second determining module, configured to perform at least one of the following operations based on the sensing QoS information:
determining a sensing link;
determining a sensing manner;
determining a sensing signal;
determining configuration information of the sensing signal;
determining the sensing node;
triggering establishment and/or modification of a sensing data transmission channel; and
generating configuration information of sensing data transmission.

In some embodiments, the sensing QoS implementation apparatus 30 further includes:
a third sending module, configured to send one or more of information about the determined sensing link, information about the determined sensing manner, information about the determined sensing signal, the determined configuration information of the sensing signal, and the determined configuration information of sensing data transmission to the sensing node.

In some embodiments, the sensing QoS implementation apparatus is a sensing function instance.

The first obtaining module is configured to: receive a sensing request, and obtain the required sensing QoS information based on sensing QoS information included in the sensing request.

The sensing QoS implementation apparatus 30 further includes:
a second receiving module, configured to receive a measurement result of the sensing measurement quantity sent by the sensing node;
a sensing result generation module, configured to generate a sensing result based on the measurement result; and
a fourth sending module, configured to send a sensing request response, where the sensing request response includes the sensing result.

In some embodiments, the sensing QoS implementation apparatus 30 further includes:
the first sending module 33, configured to send the sensing QoS information to a base station, and the base station determines the at least one of the sensing measurement quantity and the configuration information of the sensing measurement quantity based on the sensing QoS information; or
the first sending module 33, configured to send the sensing QoS information to a terminal, and the terminal determines the at least one of the sensing measurement quantity and the configuration information of the sensing measurement quantity based on the sensing QoS information.

In some embodiments, the first determining module is configured to: determine the configuration information of the sensing measurement quantity based on the sensing QoS information, and send a negotiation request for the configuration information of the sensing measurement quantity to the base station, or send a negotiation request for the configuration information of the sensing measurement quantity and the sensing QoS information to the base station; receive a negotiation result sent by the base station, where the negotiation result includes one of the following: the base station accepts the configuration information of the sensing measurement quantity, and the base station does not accept the configuration information of the sensing measurement quantity and a reason of nonacceptance and/or configuration information of a sensing measurement quantity suggested by the base station; and generate configuration information of a final sensing measurement quantity based on the negotiation result.

In some embodiments, the sensing QoS implementation apparatus is the base station or the terminal.

The first obtaining module 31 is configured to receive the sensing QoS information sent by a sensing function instance.

The sensing QoS implementation apparatus in this embodiment of this application may be an electronic device, for example, an electronic device having an operating system; or may be a component in an electronic device, for example, an integrated circuit or a chip. The electronic device may be a terminal, or may be a device other than a terminal. For example, the terminal may include but is not limited to a type of the terminal 11 illustrated above. Other devices may be a server, a Network Attached Storage (NAS), and the like. This is not specifically limited in this embodiment of this application.

The sensing QoS implementation apparatus provided in this embodiment of this application can implement the various processes implemented in the method embodiment in FIG. 2, and the same technical effects can be achieved. To avoid repetition, details are not described herein again.

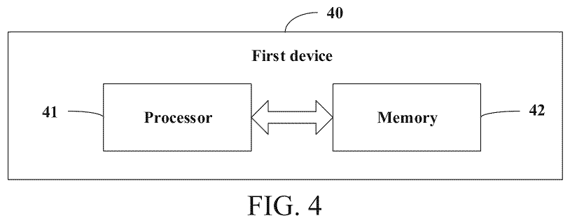

As shown in FIG. 4, an embodiment of this application further provides a first device 40, including a processor 41 and a memory 42. The memory 42 stores a program or instructions that can be run on the processor 41. When the program or instructions are executed by the processor 41, the various steps in the foregoing sensing QoS implementation method embodiment are implemented, and the same technical effects can be achieved. To avoid repetition, details are not described herein again.

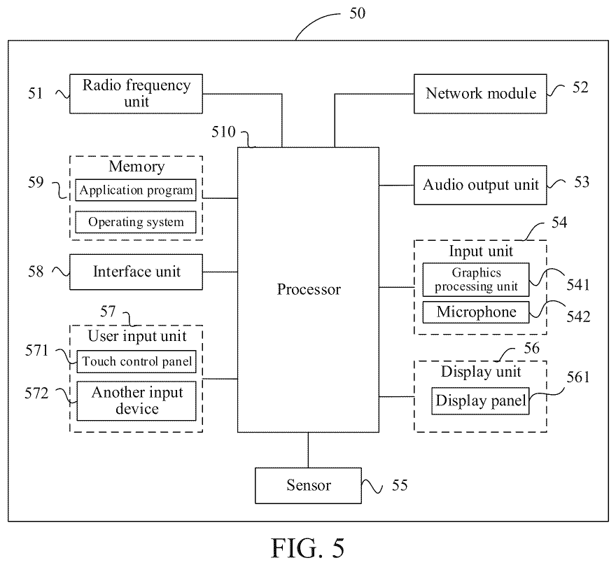

An embodiment of this application further provides a terminal, including a processor and a communication interface. The processor is configured to: obtain sensing QoS information, where the sensing QoS information includes at least one of QoS information related to a sensing service and QoS information related to a sensing measurement quantity; and determine at least one of the sensing measurement quantity and configuration information of the sensing measurement quantity based on the sensing QOS information; or the communication interface is configured to send the sensing QoS information to a second device. The terminal embodiment corresponds to the foregoing sensing QoS implementation method embodiment performed by the terminal. The implementation processes and implementations of the foregoing method embodiment are all applicable to the terminal embodiment, and the same technical effects can be achieved. FIG. 5 is a diagram of a hardware structure of a terminal according to an embodiment of this application.

The terminal 50 includes but is not limited to at least some of a radio frequency unit 51, a network module 52, an audio output unit 53, an input unit 54, a sensor 55, a display unit 56, a user input unit 57, an interface unit 58, a memory 59, a processor 510, and the like.

A person skilled in the art may understand that the terminal 50 may further include a power supply (for example, a battery) that powers various components. The power supply may be logically connected to the processor 510 through a power management system, to implement functions such as charging, discharging, and power consumption management through the power management system. The structure of the terminal shown in FIG. 5 does not constitute any limitation on the terminal. The terminal may include more or fewer components than those shown in the figure, or some components may be combined, or a different component arrangement may be used. Details are not described herein.

It should be understood that in this embodiment of this application, the input unit 54 may include a Graphics Processing Unit (GPU) 541 and a microphone 542. The graphics processing unit 541 processes image data of a static picture or a video obtained by an image capturing apparatus (for example, a camera) in a video capturing mode or an image capturing mode. The display unit 56 may include a display panel 561. The display panel 561 may be configured in a form of a liquid crystal display, an organic light-emitting diode, or the like. The user input unit 57 includes at least one of a touch control panel 571 and another input device 572. The touch control panel 571 is also referred to as a touchscreen. The touch control panel 571 may include a touch detection apparatus and a touch controller. The another input device 572 may include but is not limited to a physical keyboard, a function key (for example, a volume control key or an on/off key), a trackball, a mouse, and a joystick. Details are not described herein.

In this embodiment of this application, after receiving downlink data from a network side device, the radio frequency unit 51 may transmit the downlink data to the processor 510 for processing. In addition, the radio frequency unit 51 may send uplink data to the network side device. Usually, the radio frequency unit 51 includes but is not limited to an antenna, an amplifier, a transceiver, a coupler, a low noise amplifier, a duplexer, and the like.

The memory 59 may be configured to store a software program or instructions and various data. The memory 59 may mainly include a first storage area storing a program or instructions and a second storage area storing data. The first storage area may store an operating system, an application program or instructions (for example, an audio play function or an image play function) required by at least one function, and the like. In addition, the memory 59 may include a volatile memory or a nonvolatile memory, or the memory 59 may include both a volatile memory and a nonvolatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), or a Direct Rambus RAM (DRRAM). In this embodiment of this application, the memory 59 includes but is not limited to these and any other memories of appropriate types.

The processor 510 may include one or more processing units. In some embodiments, the processor 510 is integrated with an application processor and a modem processor. The application processor mainly processes an operation related to an operating system, a user interface, an application program, and the like. The modem processor mainly processes a wireless communication signal, for example, a baseband processor. It can be understood that the modem processor may not be integrated into the processor 510.

The radio frequency unit 51 is configured to obtain sensing QoS information.

The processor 510 is configured to determine at least one of a sensing measurement quantity and configuration information of the sensing measurement quantity based on the sensing QoS information.

In this embodiment of this application, a first device can obtain the sensing QoS information, and determine the sensing measurement quantity and/or the configuration information of the sensing measurement quantity based on the sensing QoS information, and further can assist a sensing measurement node in measuring the sensing measurement quantity to obtain a sensing result, satisfying a sensing QoS requirement of a sensing service.

In this embodiment of this application, the configuration information of the sensing measurement quantity includes at least one of the following:
a sensing measurement quantity of sensing measurement;
a sensing signal on which sensing measurement needs to be performed;
a periodicity and/or quantity of sensing signals that corresponds to a measurement result of the sensing measurement quantity;
time domain and frequency domain resource information used to report the measurement result of the sensing measurement quantity;
a time interval of reporting the measurement result of the sensing measurement quantity;
tag information that needs to be reported when the measurement result of the sensing measurement quantity is reported; and
a constraint of sensing measurement.

In some embodiments, the sensing QoS information includes at least one of the following: a sensing service QoS parameter and a sensing measurement quantity QoS parameter.

In some embodiments, the sensing service QoS parameter includes at least one of the following:
a sensing resource type;
a sensing response time;
sensing service availability;
a sensing service area;
sensing accuracy;
a sensing service priority;
sensing resolution; and
an update frequency of the sensing result.

In some embodiments, the sensing measurement quantity QoS parameter includes at least one of the following:
a periodicity and/or quantity of sensing signals that corresponds to a measurement result of the sensing measurement quantity;
a time of measuring the sensing measurement quantity;
a time interval of reporting the measurement result of the sensing measurement quantity;
whether to report tag information when reporting the measurement result of the sensing measurement quantity, where the tag information includes at least one of a time tag, a frequency tag, a geolocation tag, a UE tag, a resource tag of a sensing signal, and a quality tag of the sensing signal; and
a constraint of sensing measurement.

In some embodiments, the sensing measurement quantity QoS parameter is a QoS requirement in terms of a sensing measurement quantity or a QoS requirement in terms of a sensing measurement quantity group.

In some embodiments, the sensing QoS information further includes at least one of the following: a sensing signal QoS parameter and a sensing data transmission QoS parameter.

In some embodiments, the sensing signal QoS parameter includes at least one of the following:
a priority of a sensing signal;
a frequency domain bandwidth occupied by the sensing signal, where a unit of the frequency domain bandwidth is at least one of hertz, subcarrier, resource block, and bandwidth part;
time information of the sensing signal, where the time information includes at least one of a time length, a time periodicity, time information of each periodicity sensing signal, a protection interval, burst duration, and a time interval;
a transmit power of the sensing signal;
waveform quality of the sensing signal;
a quantity of transmit ports of the sensing signal;
a beam width of the sensing signal;
frequency domain continuity of the sensing signal;
a type of the sensing signal; and
an algorithm gain adjustment of the sensing signal.

In some embodiments, the sensing data transmission QoS parameter includes at least one of the following:
a priority of sensing data;
a type of the sensing data;
a transmission resource type of the sensing data;
a packet delay budget in sensing data transmission;
delay variation in sensing data transmission;
a packet error rate in sensing data transmission;
a burst time of the sensing data; and
a burst size of the sensing data, where
the sensing data includes a measurement result of the sensing measurement quantity.

In some embodiments, the sensing QoS information includes at least one of the following:
a sensing resource type;
a sensing response time;
sensing service availability;
a sensing service area;
sensing accuracy;
a periodicity and/or quantity of sensing signals that corresponds to a measurement result of the sensing measurement quantity;
a time of measuring the sensing measurement quantity;
a time interval of reporting the measurement result of the sensing measurement quantity;
whether to report tag information when reporting the measurement result of the sensing measurement quantity, where the tag information includes at least one of a time tag, a frequency tag, a geolocation tag, a UE tag, a resource tag of a sensing signal, and a quality tag of the sensing signal;
a constraint of sensing measurement;
a sensing service priority;
sensing resolution; and
an update frequency of the sensing result.

In some embodiments, the sensing QoS information further includes at least one of the following:
a priority of a sensing signal;
a frequency domain total bandwidth occupied by the sensing signal;
a repetition periodicity of the sensing signal;
a time domain length occupied by the sensing signal;
a transmit power of the sensing signal;
waveform quality of the sensing signal;
a quantity of transmit ports of the sensing signal;
a beam width of the sensing signal;
frequency domain continuity of the sensing signal;
a type of the sensing signal;
an algorithm gain adjustment of the sensing signal;
a priority of sensing data;
a type of the sensing data;
a transmission resource type of the sensing data;
a packet delay budget in sensing data transmission;
delay variation in sensing data transmission;
a packet error rate in sensing data transmission;
a burst time of the sensing data; and
a burst size of the sensing data, where
the sensing data includes a measurement result of the sensing measurement quantity.

In some embodiments, the sensing QoS information is indicated by using a value of a sensing quality identifier, and different values of the sensing quality identifier correspond to different sensing QoS information parameter combinations; or
the sensing QoS information is indicated by using service level indication information, and different service level indication information corresponds to different sensing QoS information parameter combinations.

In some embodiments, a value of at least one parameter in the sensing QoS information is indicated by using a value with a minimum requirement; and/or
a value of at least one parameter in the sensing QoS information is indicated in an interval manner.

In some embodiments, the radio frequency unit 51 is further configured to send information about the determined sensing measurement quantity and/or the determined configuration information of the sensing measurement quantity to a sensing node.

In some embodiments, the processor 510 is further configured to perform at least one of the following operations based on the sensing QoS information:
determining a sensing link;
determining a sensing manner;
determining a sensing signal;
determining configuration information of the sensing signal;
determining the sensing node;
triggering establishment and/or modification of a sensing data transmission channel; and
generating configuration information of sensing data transmission.

In some embodiments, the radio frequency unit 51 is further configured to send one or more of information about the determined sensing link, information about the determined sensing manner, information about the determined sensing signal, the determined configuration information of the sensing signal, and the determined configuration information of sensing data transmission to the sensing node.

In some embodiments, the radio frequency unit 51 is further configured to receive the sensing QoS information sent by a sensing function instance.

An embodiment of this application further provides a network side device, including a processor and a communication interface. The processor is configured to: obtain sensing QoS information, where the sensing QoS information includes at least one of QoS information related to a sensing service and QoS information related to a sensing measurement quantity; and determine at least one of the sensing measurement quantity and configuration information of the sensing measurement quantity based on the sensing QoS information; or the communication interface is configured to send the sensing QoS information to a second device. The network side device embodiment corresponds to the foregoing the sensing QoS implementation method embodiment performed by the network side device. The implementation processes and implementations of the foregoing method embodiment are all applicable to the network side device embodiment, and the same technical effects can be achieved.

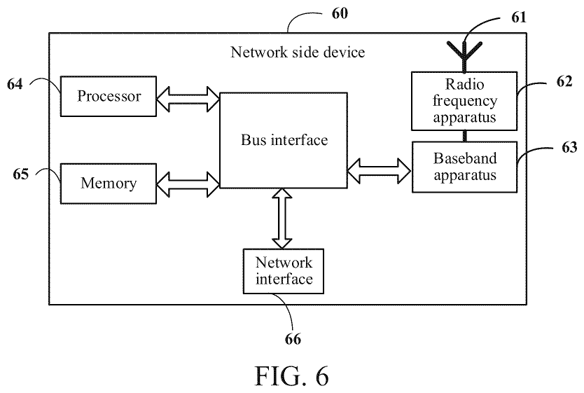

An embodiment of this application further provides a network side device. As shown in FIG. 6, the network side device 60 includes: an antenna 61, a radio frequency apparatus 62, a baseband apparatus 63, a processor 64, and a memory 65. The antenna 61 is connected to the radio frequency apparatus 62. In an uplink direction, the radio frequency apparatus 62 receives information through the antenna 61, and sends the received information to the baseband apparatus 63 for processing. In a downlink direction, the baseband apparatus 63 processes to-be-sent information, and sends the information to the radio frequency apparatus 62. The radio frequency apparatus 62 sends the received information through the antenna 61 after processing the received information.

The method performed by the network side device in the foregoing embodiments may be implemented in the baseband apparatus 63. The baseband apparatus 63 includes a baseband processor.

The baseband apparatus 63 may include, for example, at least one baseband board. The baseband board is provided with a plurality of chips. As shown in FIG. 6, one of the chips may be, for example, a baseband processor, and is connected to the memory 65 through a bus interface, to invoke the program in the memory 65 to perform the operations of the network device shown in the foregoing method embodiments.

The network side device may further include a network interface 66. The interface is, for example, a common public radio interface (CPRI).

The network side device 60 in this embodiment of this application further includes instructions or a program that is stored on the memory 65 and that can be run on the processor 64. The processor 64 invokes the instructions or program in the memory 65 to perform the method performed by the modules shown in FIG. 3, and the same technical effects can be achieved. To avoid repetition, details are not described herein again.

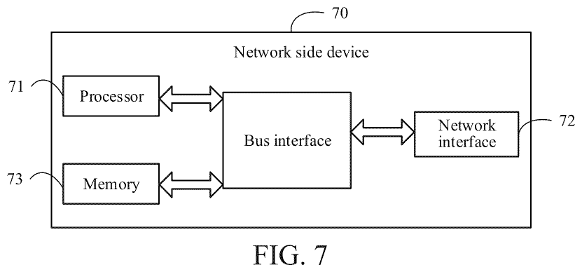

An embodiment of this application further provides a network side device. As shown in FIG. 7, the network side device 70 includes: a processor 71, a network interface 72, and a memory 73. The network interface 72 is, for example, a common public radio interface (CPRI).

The network side device 70 in this embodiment of this application further includes instructions or a program that is stored on the memory 73 and that can be run on the processor 71. The processor 71 invokes the instructions or program in the memory 73 to perform the method performed by the modules shown in FIG. 3, and the same technical effects can be achieved. To avoid repetition, details are not described herein again.

An embodiment of this application further provides a readable storage medium. The readable storage medium stores a program or instructions. When the program or instructions are executed by a processor, the processes in the sensing QoS implementation method embodiment are implemented, and the same technical effects can be achieved. To avoid repetition, details are not described herein again.

The processor is the processor in the terminal in the foregoing embodiment. The readable storage medium includes a computer-readable storage medium, for example, a computer read-only memory ROM, a random access memory RAM, a floppy disk, or an optical disc.

An embodiment of this application further provides a chip. The chip includes a processor and a communication interface. The communication interface is coupled to the processor. The processor is configured to run a program or instructions to implement the processes in the sensing QoS implementation method embodiment, and the same technical effects can be achieved. To avoid repetition, details are not described herein again.

It should be understood that the chip in this embodiment of this application may also be referred to as a system-level chip, a system chip, a chip system, a system-on-a-chip chip, or the like.

An embodiment of this application further provides a computer program/program product. The computer program/program product is stored in a storage medium, the computer program/program product is executed by at least one processor to implement the processes in the sensing QoS implementation method embodiment, and the same technical effects can be achieved. To avoid repetition, details are not described herein again.

An embodiment of this application further provides a communication system, including a terminal and a network side device. The terminal may be configured to perform the steps of the sensing QoS implementation method described above, or the network side device may be configured to perform the steps of the sensing QoS implementation method described above.

It should be noted that in this specification, the term “include”, “include”, or any other variants thereof are intended to encompass in a non-exclusive mode, so that a process, a method, an object, or an apparatus including a series of elements not only includes those elements, but also includes other elements that are not explicitly listed, or elements that are inherent to such a process, a method, an object, or an apparatus. An element defined by the phrase “including a . . . ” does not exclude the presence of the same element in the process, method, object, or apparatus including the element, without more restrictions. In addition, it should be noted that the scopes of the methods and apparatus in the embodiments of this application are not limited to performing functions in the shown or discussed order, but may also include performing functions in a substantially simultaneous manner or in a reverse order depending on involved functions. For example, the described methods may be performed in an order different from that described, and various steps may be added, omitted, or combined. Furthermore, features described with reference to some examples may be combined in other examples.

Through the foregoing descriptions of the implementations, a person skilled in the art can clearly understand that the methods in the foregoing embodiments can be implemented by software plus a necessary general hardware platform, and can also be implemented by hardware, but in many cases the former is the better implementation. Based on such understanding, the technical solutions of this application essentially, or the part contributing to the prior art, may be presented in a form of a computer software product. The computer software product is stored in a storage medium (for example, a ROM/RAM, a floppy disk, or an optical disc) including several instructions to enable a terminal (which may be a mobile phone, a computer, a server, a conditioner, a network device, or the like) to perform the methods described in the embodiments of this application.

The embodiments of this application are described above with reference to the accompanying drawings. However, this application is not limited to the foregoing specific implementations. The foregoing specific implementations are only illustrative and not restrictive. Inspired by this application, a person of ordinary skill in the art can further make many forms without departing from the purpose of this application and the scope protected by the claims, all of which shall fall within the protection scope of this application.

What is claimed is:

1. A method for sensing quality of service (QOS), comprising:
obtaining, by a first device, sensing QOS information, wherein the sensing QoS information comprises at least one of QoS information related to a sensing service or QoS information related to a sensing measurement quantity; and
determining, by the first device, at least one of the sensing measurement quantity or configuration information of the sensing measurement quantity based on the sensing QoS information; or sending, by the first device, the sensing QoS information to a second device.

2. The method according to claim 1, wherein the sensing QoS information comprises at least one of the following: a sensing service QoS parameter or a sensing measurement quantity QoS parameter.

3. The method according to claim 2, wherein the sensing service QoS parameter comprises at least one of the following:
a sensing resource type;
sensing response time;
sensing service availability;
a sensing service area;
sensing accuracy;
a sensing service priority;
sensing resolution; or
update frequency of a sensing result.

4. The method according to claim 2, wherein the sensing measurement quantity QoS parameter comprises at least one of the following:
a periodicity or quantity of sensing signals that corresponds to a measurement result of the sensing measurement quantity;
a time of measuring the sensing measurement quantity;
a time interval of reporting the measurement result of the sensing measurement quantity;
whether to report tag information when reporting the measurement result of the sensing measurement quantity, wherein the tag information comprises at least one of a time tag, a frequency tag, a geolocation tag, a user equipment (UE) tag, a resource tag of a sensing signal, or a quality tag of the sensing signal; or
a constraint of sensing measurement.

5. The method according to claim 4, wherein the sensing measurement quantity QoS parameter is a QoS requirement in terms of a sensing measurement quantity or a QoS requirement in terms of a sensing measurement quantity group.

6. The method according to claim 2, wherein the sensing QoS information further comprises at least one of the following: a sensing signal QoS parameter or a sensing data transmission QoS parameter.

7. The method according to claim 6, wherein the sensing signal QoS parameter comprises at least one of the following:
a priority of a sensing signal;
a frequency domain bandwidth occupied by the sensing signal, wherein a unit of the frequency domain bandwidth is at least one of hertz, subcarrier, resource block, or bandwidth part;
time information of the sensing signal, wherein the time information comprises at least one of a time length, a time periodicity, time information of each periodicity sensing signal, a protection interval, burst duration, or a time interval;
a transmit power of the sensing signal;
waveform quality of the sensing signal;
a quantity of transmit ports of the sensing signal;
a beam width of the sensing signal;
frequency domain continuity of the sensing signal;
a type of the sensing signal; or
an algorithm gain adjustment of the sensing signal.

8. The method according to claim 6, wherein the sensing data transmission QoS parameter comprises at least one of the following:
a transmission priority of sensing data;
a type of the sensing data;
a transmission resource type of the sensing data;
a packet delay budget in sensing data transmission;
delay variation in sensing data transmission;
a packet error rate in sensing data transmission;
a burst time of the sensing data; or
a burst size of the sensing data,
wherein the sensing data comprises a measurement result of the sensing measurement quantity.

9. The method according to claim 1, wherein the sensing QoS information comprises at least one of the following:
a sensing resource type;
a sensing response time;
sensing service availability;
a sensing service area;
sensing accuracy;
a periodicity or quantity of sensing signals that corresponds to a measurement result of the sensing measurement quantity;
a time of measuring the sensing measurement quantity;
a time interval of reporting the measurement result of the sensing measurement quantity;
whether to report tag information when reporting the measurement result of the sensing measurement quantity, wherein the tag information comprises at least one of a time tag, a frequency tag, a geolocation tag, a user equipment (UE) tag, a resource tag of a sensing signal, or a quality tag of the sensing signal;
a constraint of sensing measurement;
a sensing service priority;
sensing resolution; or
update frequency of a sensing result.

10. The method according to claim 9, wherein the sensing QoS information further comprises at least one of the following:
a priority of a sensing signal;
a frequency domain bandwidth occupied by the sensing signal, wherein a unit of the frequency domain bandwidth is at least one of hertz, subcarrier, resource block, or bandwidth part;
time information of the sensing signal, wherein the time information comprises at least one of a time length, a time periodicity, time information of each periodicity sensing signal, a protection interval, burst duration, or a time interval;
a transmit power of the sensing signal;
waveform quality of the sensing signal;
a quantity of transmit ports of the sensing signal;
a beam width of the sensing signal;
frequency domain continuity of the sensing signal;
a type of the sensing signal;
an algorithm gain adjustment of the sensing signal;
a transmission priority of sensing data;
a type of the sensing data;
a transmission resource type of the sensing data;
a packet delay budget in sensing data transmission;
delay variation in sensing data transmission;
a packet error rate in sensing data transmission;
a burst time of the sensing data; or
a burst size of the sensing data,
wherein the sensing data comprises a measurement result of the sensing measurement quantity.

11. The method according to claim 1, wherein the sensing QoS information is indicated by using a value of a sensing quality identifier, and different values of the sensing quality identifier correspond to different sensing QoS information parameter combinations; or
the sensing QoS information is indicated by using service level indication information, and different service level indication information corresponds to different sensing QoS information parameter combinations.

12. The method according to claim 1, wherein a value of at least one parameter in the sensing QoS information is indicated by using a value with a minimum requirement; or
a value of at least one parameter in the sensing QoS information is indicated in an interval manner.

13. The method according to claim 1, wherein the configuration information of the sensing measurement quantity comprises at least one of the following:
a sensing measurement quantity of sensing measurement;
a sensing signal on which sensing measurement needs to be performed;
a periodicity or quantity of sensing signals that corresponds to a measurement result of the sensing measurement quantity;
time domain or frequency domain resource information used to report the measurement result of the sensing measurement quantity;
a time interval of reporting the measurement result of the sensing measurement quantity;
tag information that needs to be reported when the measurement result of the sensing measurement quantity is reported; or
a constraint of sensing measurement.

14. The method according to claim 1, further comprising: sending, by the first device, information about the determined sensing measurement quantity or the determined configuration information of the sensing measurement quantity to a sensing node.

15. The method according to claim 1, further comprising: performing, by the first device, at least one of the following operations based on the sensing QoS information:
determining a sensing link;
determining a sensing manner;
determining a sensing signal;
determining configuration information of the sensing signal;
determining the sensing node;
triggering establishment or modification of a sensing data transmission channel; or
determining configuration information of sensing data transmission.

16. The method according to claim 15, further comprising: sending, by the first device, one or more of information about the determined sensing link, information about the determined sensing manner, information about the determined sensing signal, the determined configuration information of the sensing signal, and the determined configuration information of sensing data transmission to the sensing node.

17. The method according to claim 1, wherein the first device is a sensing function instance; and
the obtaining, by a first device, sensing QoS information comprises:
receiving, by the sensing function instance, a sensing request; and
obtaining, by the sensing function instance, the required sensing QoS information based on sensing QoS information comprised in the sensing request.

18. The method according to claim 17, wherein after determining, by the first device, at least one of the sensing measurement quantity and configuration information of the sensing measurement quantity based on the sensing QoS information, the method further comprises:
receiving, by the sensing function instance, a measurement result of the sensing measurement quantity sent by a sensing node;
generating, by the sensing function instance, a sensing result based on the measurement result; and
sending, by the sensing function instance, a sensing request response, wherein the sensing request response comprises the sensing result.

19. A first device, comprising: a memory storing a computer program; and a processor coupled to the memory and configured to execute the computer program to perform operations comprising:
obtaining sensing QoS information, wherein the sensing QoS information comprises at least one of QoS information related to a sensing service or QoS information related to a sensing measurement quantity; and
determining at least one of the sensing measurement quantity or configuration information of the sensing measurement quantity based on the sensing QoS information; or sending the sensing QoS information to a second device.

20. A non-transitory computer-readable storage medium, storing a computer program, when the computer program is executed by a processor, causes the processor to perform operations comprising:
obtaining, by a first device, sensing QoS information, wherein the sensing QoS information comprises at least one of QoS information related to a sensing service or QoS information related to a sensing measurement quantity; and
determining, by the first device, at least one of the sensing measurement quantity or configuration information of the sensing measurement quantity based on the sensing QoS information; or sending, by the first device, the sensing QoS information to a second device.
